(19) United States
(12) Patent Application Publication
(10) Pub. No.: US 2019/0239069 A1
(43) Pub. Date: Aug. 1, 2019

(54) INFORMATION PROCESSING SYSTEM, ELECTRONIC WHITEBOARD APPARATUS, AND NON-TRANSITORY RECORDING MEDIUM

(71) Applicant: Yukinari TOYOTA, Kanagawa (JP)

(72) Inventor: Yukinari TOYOTA, Kanagawa (JP)

(73) Assignee: Ricoh Company, Ltd., Tokyo (JP)

(21) Appl. No.: 16/251,612

(22) Filed: Jan. 18, 2019

(30) Foreign Application Priority Data
Jan. 31, 2018 (JP) 2018-015942

(51) Int. Cl. H04W 12/06; G06F 21/12; G06F 21/34; G06F 21/74; B43L 1/04

(52) U.S. Cl. CPC H04W 12/06; G06F 21/121; B43L 1/04; G06F 21/74; G06F 21/34

(57) ABSTRACT

An information processing system including a plurality of authentication methods for identifying a user is provided. The information processing system includes a memory, and a processor coupled to the memory and configured to, identify the user by a given authentication method of the plurality of authentication methods, the authentication methods being associated with actions allowed to users, receive an instruction to execute an action from the user, make a determination whether the instruction to execute the action is allowed based on the given authentication method, and execute the action or restrict the action from being executed based on a result of the determination.

### CROSS-REFERENCE TO RELATED APPLICATION

The present application claims priority under 35 U.S.C. § 119 to Japanese Patent Application No. 2018-015942, filed on Jan. 31, 2018, the entire contents of which are incorporated herein by reference.

### BACKGROUND OF THE INVENTION

### 1. Field of the Invention

The disclosures herein generally relate to an information processing system, an electronic whiteboard apparatus, and a non-transitory recording medium.

### 2. Description of the Related Art

Conventionally, electronic whiteboard apparatuses have been used in conferences attended by a plurality of users. Some of the conventional electronic whiteboard apparatuses used in conferences attended by a plurality of users have mechanisms for ensuring confidentiality.

For example, such conventional electronic whiteboard apparatuses include an electronic whiteboard apparatus that effectively detects a third party participant in a conference by using face authentication so as to ensure confidentiality (see Patent Document 1, for example).

Such conventional electronic whiteboard apparatuses also include an electronic whiteboard system that requests authentication such as a signature, a personal identification number, and a password when a user accesses an electronic file that is used for an electronic whiteboard function, so as to ensure confidentiality even when the electronic whiteboard system is used by an unspecified large number of users (see Patent Document 2, for example).

Recently, authentication techniques have become widespread. Thus, it has become possible for apparatuses such as electronic whiteboard apparatuses, which are used in conferences attended by a plurality of users and allow the users to share a display screen, to include a plurality of user authentication methods such as IC card authentication and face authentication. Further, with the widespread use of cloud computing, it has also become possible for users to use external services such as storage services. Accordingly, in a conference in which an electronic whiteboard is used, it is useful if users can obtain images to be displayed on the screen, from external services available to the users.

However, the accuracy of authentication methods included in such electronic whiteboard apparatuses sometimes varies. Thus, in the conventional electronic whiteboard apparatuses, a user mistakenly authenticated by a low-accuracy authentication method becomes able to operate a file owned by an original user, which is not preferable in terms of security.

### RELATED-ART DOCUMENTS

### Patent Documents

[Patent Document 1] Japanese Unexamined Patent

Application Publication No. 2015-99537
[Patent Document 2] Japanese Unexamined Patent Application Publication No. 2000-43486

### SUMMARY OF THE INVENTION

According to at least one embodiment, an information processing system including a plurality of authentication methods for identifying a user is provided. The information processing system comprises a memory, and a processor coupled to the memory and configured to, identify the user by a given authentication method of the plurality of authentication methods, the authentication methods being associated with actions allowed to users, receive an instruction to execute an action from the user, make a determination whether the instruction to execute the action is allowed based on the given authentication method, and execute the action or restrict the action from being executed based on a result of the determination.

### BRIEF DESCRIPTION OF THE DRAWINGS

FIG. 1 is a diagram illustrating an exemplary configuration of an information processing system according to a first embodiment;

FIG. 2 is a diagram illustrating an exemplary hardware configuration of a computer;

FIG. 3 is a diagram illustrating an example of a hardware configuration of an electronic whiteboard apparatus;

FIG. 4 is a diagram illustrating an exemplary functional configuration of the information processing system according to the first embodiment;

FIG. 5 is a diagram illustrating exemplary user service account information;

FIG. 6 is a diagram illustrating exemplary storage service storage information;

FIG. 7 is a diagram illustrating an exemplary user information list;

FIG. 8 is a diagram illustrating exemplary external service setting information;

FIG. 9 is a diagram illustrating an exemplary participant management information list;

FIG. 10 is a diagram illustrating an exemplary permission setting table on a per-authenticator/detector basis;

FIG. 11 is a flowchart illustrating an exemplary participant detecting and setting process;

FIG. 12 is a flowchart illustrating an exemplary conference-related process;

FIG. 13 is a flowchart illustrating an exemplary permission inquiring process;

FIG. 14 is a flowchart illustrating an exemplary flow of a conference utilizing the electronic whiteboard apparatus;

FIG. 15 is a diagram illustrating an exemplary operation panel displayed on the electronic whiteboard apparatus;

FIG. 16 is a diagram illustrating an exemplary user interface displayed on the electronic whiteboard apparatus in response to an operation performed on an operation panel;

FIG. 17 is a diagram illustrating an exemplary distribution screen displayed on the electronic whiteboard apparatus in response to an operation being performed on the operation panel;

FIG. 18 is a flowchart illustrating an exemplary conference participant adding process;

FIG. 19 is a diagram illustrating an exemplary participant management information list after a participant is added;

FIG. 20 is a flowchart illustrating another exemplary conference participant adding process;

FIG. 21 is a diagram illustrating another exemplary participant management information list after a participant is added;

FIG. 22 is a flowchart illustrating an exemplary file loading process;

FIG. 23 is a flowchart illustrating another exemplary permission inquiring process;

FIG. 24 is a diagram illustrating an exemplary participant management information list after an authentication/detection source is added;

FIG. 25 is a flowchart illustrating an exemplary batch distribution process;

FIG. 26 is a flowchart illustrating another exemplary permission inquiring process;

FIG. 27 is a flowchart illustrating an exemplary destination adding process;

FIG. 28 is a flowchart illustrating an exemplary process for sending a file to all destinations;

FIG. 29 is a diagram illustrating an exemplary functional configuration of an information processing system according to a second embodiment;

FIG. 30 is a diagram illustrating exemplary schedule information according to the second embodiment;

FIG. 31 is a diagram illustrating an exemplary permission setting table on a per-authenticator/detector basis according to the second embodiment;

FIG. 32 is a flowchart illustrating an exemplary conference schedule setting process according to the second embodiment;

FIG. 33 is a flowchart illustrating an exemplary permission inquiring process according to the second embodiment;

FIG. 34 is a flowchart illustrating an exemplary prospective participant adding process according to the second embodiment;

FIG. 35 is a diagram illustrating an exemplary schedule list screen according to the second embodiment;

FIG. 36 is a diagram illustrating an exemplary participant management information list after the authentication/detection source is added according to the second embodiment;

FIG. 37 is a flowchart illustrating an exemplary destination adding process according to the second embodiment;

FIG. 38 is a flowchart illustrating an exemplary process for adding a destination in accordance with a destination type according to the second embodiment;

FIG. 39 is a diagram illustrating an exemplary distribution screen according to the second embodiment;

FIG. 40 is a diagram illustrating an exemplary permission setting table on a per-authenticator/detector basis according to a third embodiment; and

FIG. 41 is a diagram illustrating an exemplary permission setting table for various authenticators/detectors.

### DESCRIPTION OF THE PREFERRED EMBODIMENTS

It is a general object of at least one embodiment of the present invention to provide an information processing system that restricts an action that can be performed by a user in accordance with an authentication method by which the user is authenticated.

In the following, embodiments of the present invention will be described with reference to the accompanying drawings. In the following embodiments, an example in which an electronic whiteboard apparatus used in a conference attended by plural users will be described. However, the electronic whiteboard apparatus may be applied not only to a conference, but also to a variety of circumstances where plural users view a display of the electronic whiteboard apparatus.

### First Embodiment

### <System Configuration>

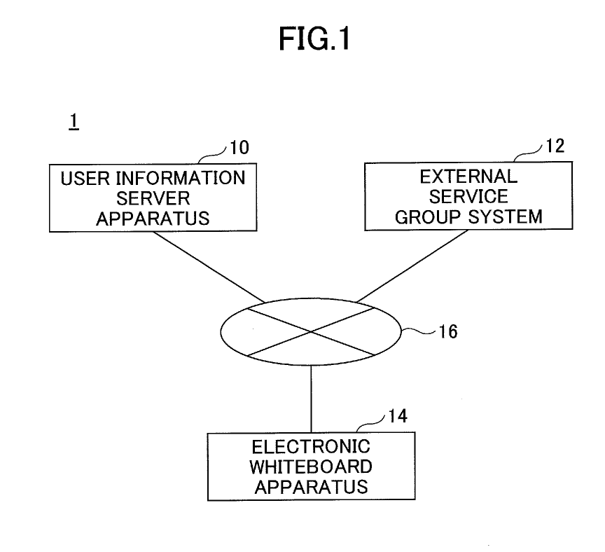

FIG. 1 is a diagram illustrating an exemplary configuration of an information processing system according to a first embodiment. In an information processing system 1 of FIG. 1, a user information server apparatus 10, at least one external service group system 12, and an electronic whiteboard apparatus 14 are communicatively connected to each other via a network 16 such as the Internet or a local area network (LAN). The user information server apparatus 10 and the electronic whiteboard apparatus 14 constitute an electronic whiteboard system. The user information server apparatus 10 and the electronic whiteboard apparatus 14 operate in conjunction with the external service group system 12 located outside the electronic whiteboard system, and provide functions related to the electronic whiteboard apparatus 14. A plurality of electronic whiteboard apparatuses 14 may be used.

An external service group provided by the external service group system 12 refers to an integrated service such as Office 365 (registered trademark), which includes a user service, a storage service, and an email service, for example. The external service group is provided in such a manner that services such as a user service, a storage service, and an email service can be used with the same user account. The external service group may be different for each user, and one or more external service groups may be provided. The external service group system 12 is implemented by one or more computers.

The user information server apparatus 10 stores information such as a user information list and external service setting information, which will be described later. Also, the user information server apparatus 10 is available from the electronic whiteboard apparatus 14 or the external service group system 12. The user information server apparatus 10 may be shared by a plurality of electronic whiteboard apparatuses 14, and is not required to be located on a same network segment. Also, the user information server apparatus 10 may be included in the electronic whiteboard apparatus 14. The user information server apparatus 10 is implemented by one or more computers.

The electronic whiteboard apparatus 14 is used in a conference attended by a plurality of users. For example, the electronic whiteboard apparatus 14 displays an image drawn by an electronic pen or by a user's hand. Also, the electronic whiteboard apparatus 14 can display an image of an electronic file, which is read from a personal computer (PC) connected via a USB memory or a cable or is read from the external service group system 12.

The electronic whiteboard apparatus 14 has a function to distribute image data being displayed on the electronic whiteboard apparatus 14 to all participants participating in a conference. Destinations to which the electronic whiteboard apparatus 14 distribute the image data includes the external service group system 12 for which a usage setting is required for each user, as will be described later. Also, the electronic whiteboard apparatus 14 has a plurality of authentication methods for authenticating a user, such as IC card authentication and face authentication.

The electronic whiteboard apparatus 14 is merely exemplary, and may be any apparatus such as a remote conference system, a display, and a projector as long as such an apparatus has a function to load and distribute (send) data to be displayed.

The configuration of the information processing system 1 illustrated in FIG. 1 is merely exemplary. For example, the electronic whiteboard apparatus 14 may be equipped with at least some functions of the user information server apparatus 10 and the external service group system 12. The information processing system 1 may be configured such that at least some functions of the user information server apparatus 10, the external service group system 12, or the electronic whiteboard apparatus 14 may be implemented by an information processing apparatus other than the user information server apparatus 10, the external service group system 12, and the electronic whiteboard apparatus 14.

### <Hardware Configuration>

### <<Computer>>

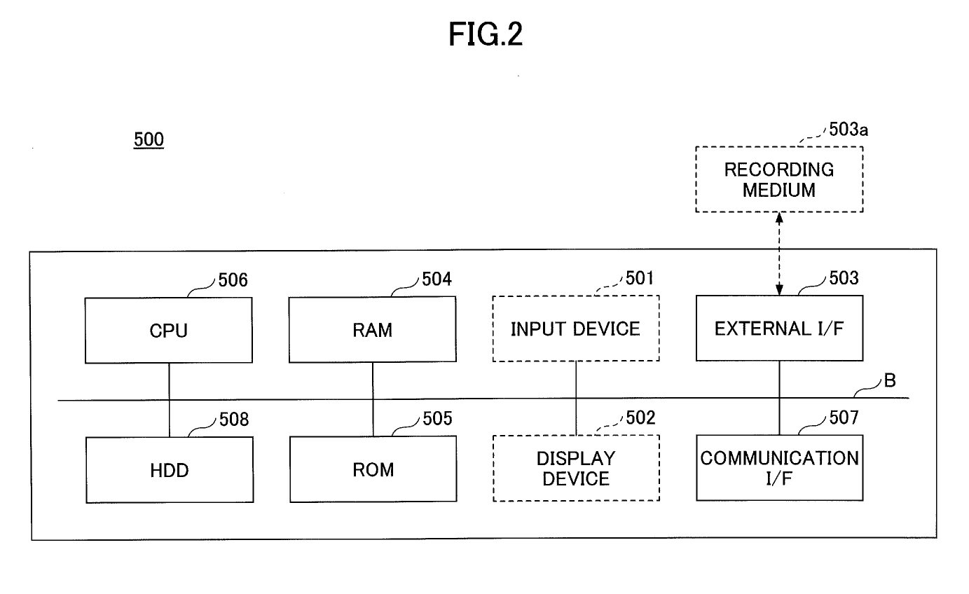

The user information server apparatus 10 and the external service group system 12 in FIG. 1 are implemented by a computer having a hardware configuration as illustrated in FIG. 2, for example. FIG. 2 is a diagram illustrating an exemplary hardware configuration of a computer.

A computer 500 illustrated in FIG. 2 includes an input device 501, a display device 502, an external I/F 503, random-access memory (RAM) 504, read-only memory (ROM) 505, a central processing unit (CPU) 506, a communication I/F 507, and a hard disk drive (HDD) 508, which are connected to each other via a bus B. Note that the input device 501 and the display device 502 may be connected and used when necessary.

The input device 501 includes a keyboard, a mouse, and a touch panel, and is used by a user to input operation signals. The display device 502 includes a display, for example, and displays a processing result obtained from the computer 500.

The communication I/F 507 is an interface for connecting the computer 500 to various networks. The computer 500 can perform data communication via the communication I/F 507.

The HDD 508 is an example of non-volatile storage that stores programs and data. The programs and data stored in the HDD 508 include an operating system (OS) that is basic software for controlling the entire computer 500, and include applications that provide functions on the OS. Instead of the HDD 508, the computer 500 may use a drive device (such as a solid-state drive) that uses flash memory as a storage medium.

The external I/F 503 is an interface with an external device. The external device includes a recording medium 503a. The computer 500 can read from and write to the recording medium 503a via the external I/F 503. The recording medium 503a includes a flexible disk, a compact disc (CD), a digital versatile disc (DVD), a secure digital (SD) memory card, a universal serial bus (USB) memory, and a subscriber identity module (SIM) card.

The ROM 505 is an example of non-volatile semiconductor memory (storage) that can retain programs and data even when the power is turned off. The ROM 505 stores programs and data such as the basic input/output system (BIOS) executed at the start of the computer 500, OS settings, and network settings. The RAM 504 is an example of volatile semiconductor memory (storage) that temporarily stores programs and data.

The CPU 506 is a processor that reads programs and data from storage such as the ROM 505 or the HDD 508 into the RAM 504 and performs operations so as to control the entire computer 500 and implement functions. The CPU 506 may be implemented by one or more processors.

The user information server apparatus 10 and the external service group system 12 can perform various processes, which will be described later, by using the hardware configuration of the computer 500 illustrated in FIG. 2, for example.

### <<Electronic Whiteboard Apparatus>>

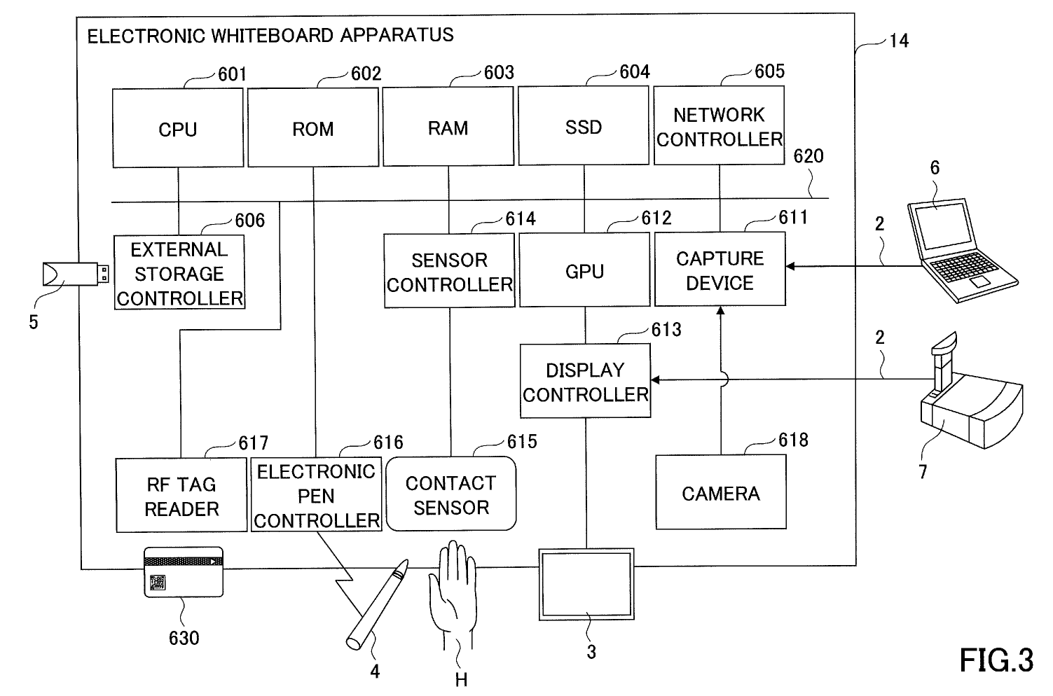

FIG. 3 is a diagram illustrating an exemplary hardware configuration of the electronic whiteboard apparatus. The electronic whiteboard apparatus 14 includes a CPU 601, ROM 602, RAM 603, a SSD 604, a network controller 605, and an external storage controller 606.

The CPU 601 controls the overall operation of the electronic whiteboard apparatus 14. The ROM 602 stores programs used to drive the CPU 601. The RAM 603 is used as a work area for the CPU 601. The SSD 604 stores various types of data such as a program for the electronic whiteboard apparatus 14. The network controller 605 controls communication with the network 16. The external storage controller 606 controls communication with a recording medium such as a USB memory 5.

Also, the electronic whiteboard apparatus includes a capture device 611, a graphics processing unit (GPU) 612, a display controller 613, a sensor controller 614, a contact sensor 615, an electronic pen controller 616, a RF tag reader 617, and a camera 618.

The capture device 611 captures video information from a PC 6 or the camera 618 as a still image file or a moving image file. The GPU 612 is specifically used for graphics. The display controller 613 controls and manages display so as to output images from the GPU 612 to a display 3 and a teleconference terminal 7. The contact sensor 615 detects an electronic pen 4 or a user's hand H that has touched the display 3.

The contact sensor 615 inputs and detects coordinates by using an infrared ray blocking method. In the method of inputting and detecting coordinates, two light receiving/emitting devices, which are placed at both upper end portions of the display 3, emit a plurality of infrared rays in parallel to the display 3, the infrared rays are reflected by reflecting members placed around the display 3, and light receivers receive light returning along the same optical paths as those of the emitted infrared rays. The contact sensor 615 outputs, to the sensor controller 614, identification (ID) of the infrared rays emitted by the two light emitting/receiving devices and blocked by an object. The sensor controller 614 identifies a coordinate position that is a contact position of the object.

Further, the contact sensor 615 does not necessarily use the infrared ray blocking method. The contact sensor 615 may use various kinds of detection methods, including: a capacitive type touch panel that identifies a contact position by detecting a change in electrostatic capacity; a resistive film type touch panel that identifies a contact position by a voltage change of two opposing resistive films; and an electromagnetic induction type touch panel that identifies a contact position by detecting electromagnetic induction caused when an object makes contact with a display part.

The electronic pen controller 616 communicates with the electronic pen 4 so as to determine whether the tip or the bottom of the pen has touched the display 3. Note that the electronic pen controller 616 may determine whether a part of the electronic pen 4 held by the user or other parts of the electronic pen 4 have touched the display 3.

The RF tag reader 617 reads identification information specific to the IC card 630 from a RF tag embedded in the IC card 630 via radio communication.

The RF tag reader 617 may be included in the electronic whiteboard apparatus 14 or may be externally provided. Note that the IC card 630 may be included in a smart device such as a smartphone. Also, the electronic whiteboard apparatus 14 may use any device other than the RF tag reader 617 as long as identification information capable of identifying a user can be obtained. For example, a biometric authentication device (such as a fingerprint, a palm print, or an iris authentication device) or a barcode reader may be used.

The electronic whiteboard apparatus 14 of FIG. 3 includes a bus line 620 such as an address bus and a data bus for electrically connecting the CPU 601, the ROM 602, the RAM 603, the SSD 604, the network controller 605, the external storage controller 606, the capture device 611, the GPU 612, the sensor controller 614, the electronic pen controller 616, and the RF tag reader 617 to each other. Note that the program for the electronic whiteboard apparatus 14 may be recorded in a computer-readable recording medium such as a compact disc read-only memory (CD-ROM) for distribution.

<Software Configuration>

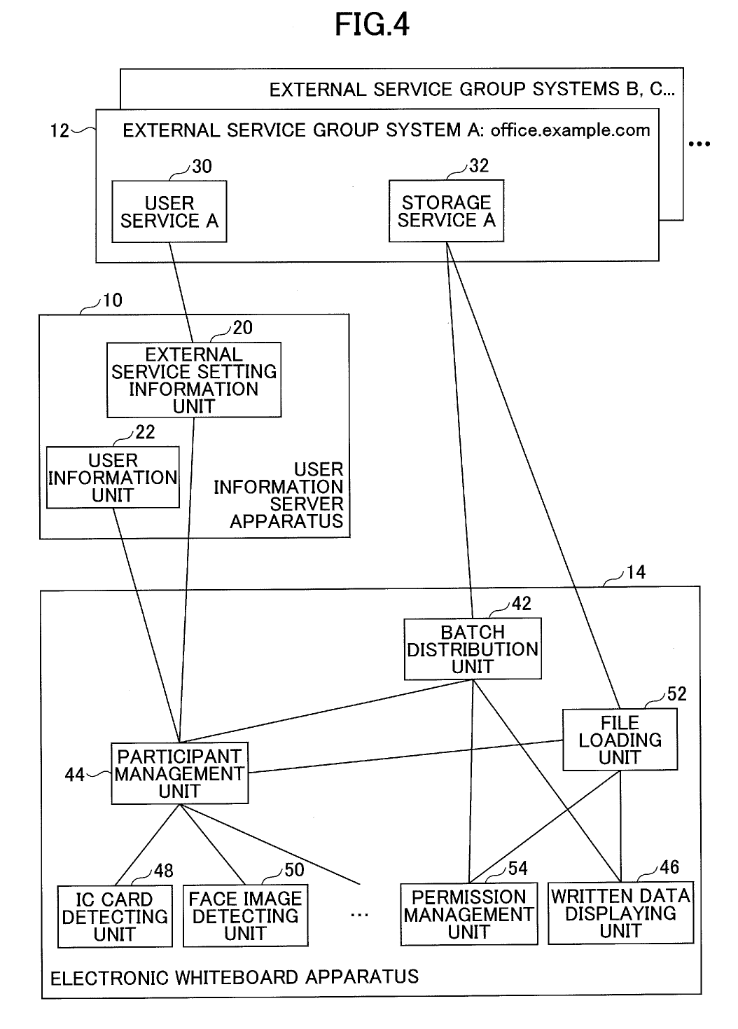

The information processing system 1 according to the first embodiment is implemented by a functional configuration as illustrated in FIG. 4, for example. FIG. 4 is a diagram illustrating an exemplary functional configuration of the information processing system according to the first embodiment. In the functional configuration of FIG. 4, a part of the configuration that is not required for the description of the present embodiment is not depicted.

The information processing system 1 of FIG. 4 includes the user information server apparatus 10, the external service group system 12, and the electronic whiteboard apparatus 14. In FIG. 4, “office.example.com” is illustrated as an example of the external service group system 12. In the external service group system 12 illustrated in FIG. 4, a user service 30 and a storage service 32 are illustrated as external service groups provided to the user.

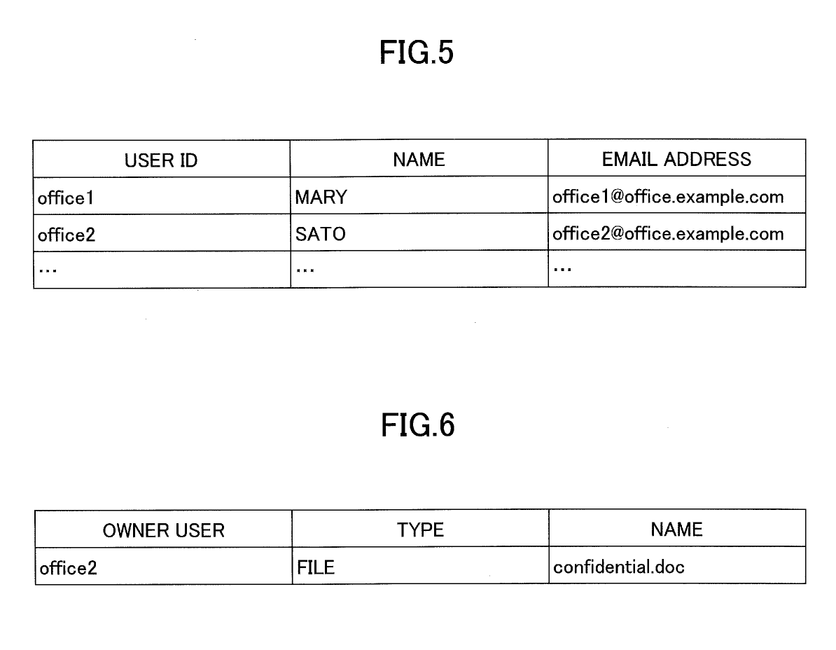

The external service group system 12 stores user service account information illustrated in FIG. 5, for example. FIG. 5 is a diagram illustrating exemplary user service account information. The user service 30 of the external service group system 12 stores a user ID, a user name, and an email address as user service account information.

The storage service 32 is storage in which a user's file can be stored. Information such as a type (a file or a folder) and a name are managed as storage service storage information on a per-user basis, as illustrated in FIG. 6. FIG. 6 is a diagram illustrating exemplary storage service storage information. The storage service 32 of the external service group system 12 stores a user ID of an owner user, a type (a file or a folder), and a name.

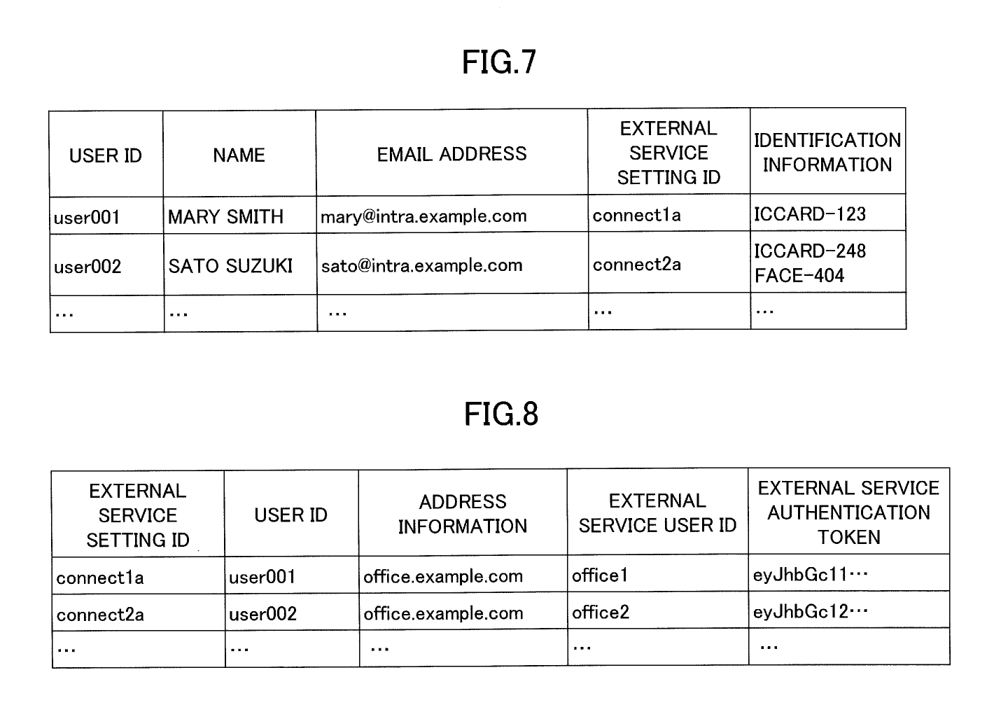

The user information server apparatus 10 includes an external service setting information unit 20 and a user information unit 22. The user information unit 22 stores a user information list illustrated in FIG. 7, for example. FIG. 7 is a diagram illustrating an exemplary user information list. The user information list stores a user ID, a name, an email address, an external service setting ID, and identification information, as illustrated in FIG. 7.

The external service setting ID is information for identifying external service setting information, which will be described later. Identification information is information for identifying a user detected by an IC card detecting unit 48 or a face image detecting unit 50. Identification information “ICCARD-123” and “ICCARD-248” of FIG. 7 are examples of identification information specific to the IC card 630 read from the IC card detecting unit 48, which will be described later. Identification information “FACE-404” in FIG. 7 is an example of identification information (feature information) specific to a user read from the face image detecting unit 50, which will be described later. With the user information list of FIG. 7, external service setting information of a user is identified.

The external service setting information unit 20 stores external service setting information as illustrated in FIG. 8, for example. FIG. 8 is a diagram illustrating exemplary external service setting information. The external service setting information is setting information that is required to use the external service group system 12 and is different on a per-user basis. The external service setting information of FIG. 8 stores an external service setting ID, a user ID, address information, an external service user ID, and an external service authentication token.

The address information and the external service user ID are examples of connection information for the external service group system 12. The external service authentication token is an example of authentication information for the external service group system 12.

The electronic whiteboard apparatus 14 includes a batch distribution unit 42, a participant management unit 44, a written data displaying unit 46, the IC card detecting unit 48, the face image detecting unit 50, a file loading unit 52, and a permission management unit 54. The IC card detecting unit 48 reads identification information from the IC card 630 of a detected user. The face image detecting unit 50 detects a user's face from an image captured by the camera 618, and reads identification information of the detected user's face.

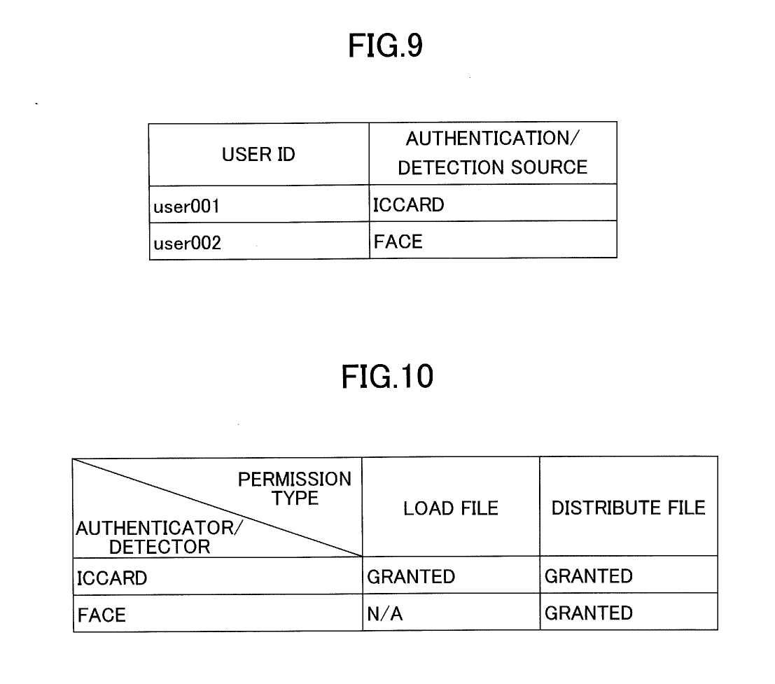

The participant management unit 44 manages conference participants by using a participant management information list of FIG. 9, for example. FIG. 9 is a diagram illustrating an exemplary participant management information list. The participant management information list stores a user ID of a participant and an authentication/detection source such as the IC card detecting unit 48 or the face image detecting unit 50 that has detected the participant.

For example, the participant management unit 44 identifies user information from the user information list of FIG. 7, by using identification information read by the IC card detecting unit 48. The participant management unit 44 stores a user ID of the identified user information in the participant management information list, in association with an authentication/detection source “ICCARD” that indicates the IC card detecting unit 48. In this way, the participant management unit 44 manages the user information of the conference participant in association with the participant management information list.

The written data displaying unit 46 receives data written to the electronic whiteboard apparatus 14 by a user, and displays the written data. The file loading unit 52 has a function and a user interface (UI) for loading a file from various services such as the storage service 32 of the external service group system 12 to be displayed on the electronic whiteboard apparatus 14.

The batch distribution unit 42 has a user interface for putting contents displayed on the electronic whiteboard apparatus 14 together into a file, and sending the file to various services such as the storage service 32 of the external service group system 12, such that the file is distributed to all destinations of conference participants. Storing a file in the storage service 32 is an example of sending a file to the storage service 32.

The permission management unit 54 determines whether a user instruction such as file loading is permitted, based on a permission setting table on a per-authenticator/detector basis of FIG. 10 and also an authentication/detection source of the participant management information list of FIG. 9. FIG. 10 is a diagram illustrating an exemplary permission setting table on a per-authenticator/detector basis.

The permission setting table on a per-authenticator/detector basis of FIG. 10 is a setting table that indicates permission types on a per-authenticator/detector basis. Specifically, in FIG. 10, permissions for performing actions are set on a per-authenticator/detector basis. For example, in FIG. 10, “ICCARD” is an authentication/detection source indicating that a user is authenticated by IC card authentication. Further, “FACE” is an authentication/detection source indicating that a user is authenticated by face authentication.

In the permission setting table on a per-authenticator/detector basis of FIG. 10, a participant detected by the IC card authentication is permitted to load and distribute files. Conversely, a participant detected by the face authentication is permitted to distribute a file, but is not permitted to load a file. This is because there may be a possibility that a participant may be impersonated or falsely detected by the face authentication (because of low accuracy). Thus, the permission setting table on a per-authenticator/detector basis of FIG. 10 has an effect of preventing information leakage.

Further, in the permission setting table on a per-authenticator/detector basis of FIG. 10, both the IC card authentication and the face authentication are permitted to distribute a file by means of batch distribution. When file distribution is performed, a file with a conference name is simply generated and is not permitted to be overwritten. Thus, because of a low security risk, file distribution is permitted by taking convenience into account. However, this is not applied to a case where a file with a conference name can be freely set by an operator of the electronic whiteboard apparatus 14, because an incident may occur due to overwriting or incorrect handling. As an example of such an incident, when answer sheets and scores are managed as a file in the storage service 32, there is a possibility that the file may be fraudulently overwritten.

The permission setting table on a per-authenticator/detector basis of FIG. 10 may differ for each electronic whiteboard apparatus 14 or for each organization to which users belong, in accordance with a security level, an operational state or an installation place of each authenticator/detector, or a policy of installation personnel.

Also, the electronic whiteboard system may include any detecting unit other than the IC card detecting unit 48 and the face image detecting unit 50. The IC card detecting unit 48, the face image detecting unit 50, and said other detecting unit may hereinafter be collectively referred to as a “participant detecting/setting unit”. Further, the file loading unit 52 and the batch distribution unit 42 may be collectively referred to as a process executing unit, and the electronic whiteboard system may include any process executing unit other than the file loading unit 52 and the batch distribution unit 42.

Furthermore, the electronic whiteboard system may individually assign permissions for performing actions as separate permission types, or may assign permissions having similar characteristics as the same permission type. In the permission setting table on a per-authenticator/detector basis of FIG. 10, permission types each may be set for a combination of a plurality of authenticators/detectors.

### <Processes>

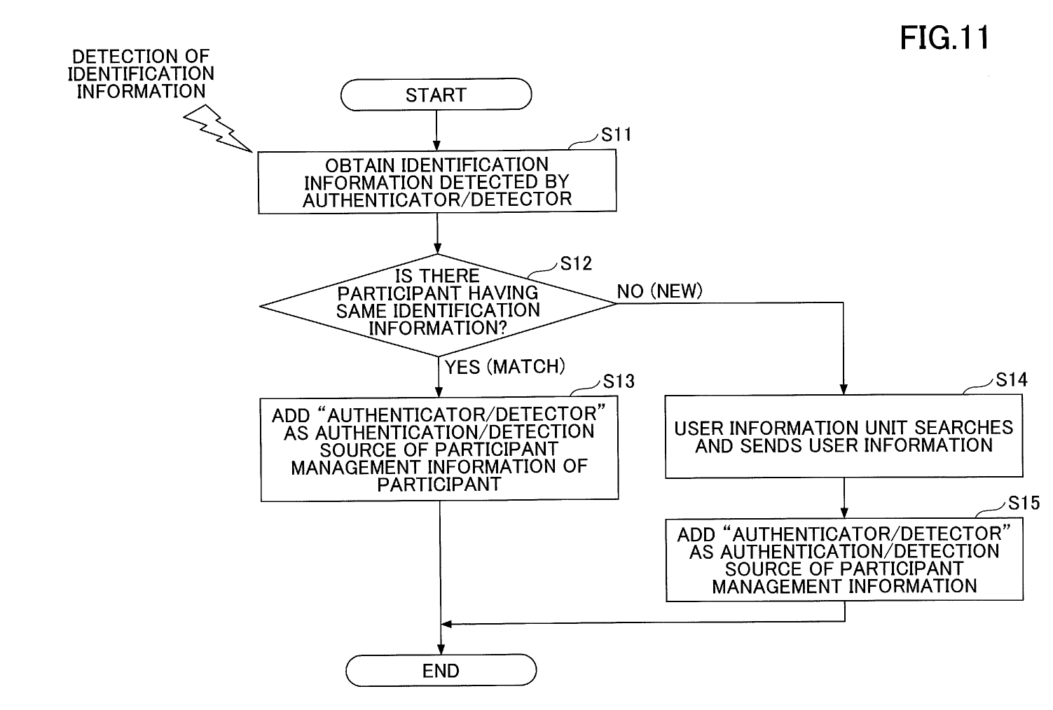

The information processing system 1 according to the first embodiment causes a participant to be included in the participant management information list of FIG. 9 by the following procedure, for example. FIG. 11 is a flowchart illustrating an exemplary participant detecting and setting process. In the following, an example in which the IC card detecting unit 48 and the face image detecting unit 50 are regarded as a participant detecting/setting unit will be described.

In step S11, the participant management unit 44 obtains identification information of a participant detected by the IC card detecting unit 48 or the face image detecting unit 50 serving as a participant detecting/setting unit. In step S12, the participant management unit 44 utilizes the user information list illustrated in FIG. 7 to determine whether a participant having the same identification information is included in the participant management information list of FIG. 9.

When the participant management information list of FIG. 9 includes a participant having the identification information, the participant management unit 44 proceeds to step S13. In step S13, the participant management unit 44 adds an authenticator/detector (the participant detecting/setting unit), which has detected the identification information, as an authentication/detection source of the participant management information list of FIG. 9 in association with the participant corresponding to the identification information detected in step S11.

When the participant management information list of FIG. 9 does not include a participant having the identification information, the participant management unit 44 proceeds to step S14. In step S14, the participant management unit 44 requests the user information unit 22 to search user information by using the identification information obtained in step S11. The participant management unit 44 obtains user information corresponding to the identification information obtained in step S11, from the user information unit 22 as a response to the request for search.

In step S15, the participant management unit 44 adds, to the participant management information list of FIG. 9, participant management information in which a user ID included in the user information obtained as the response in step S14 is associated with the authenticator/detector that has detected the identification information.

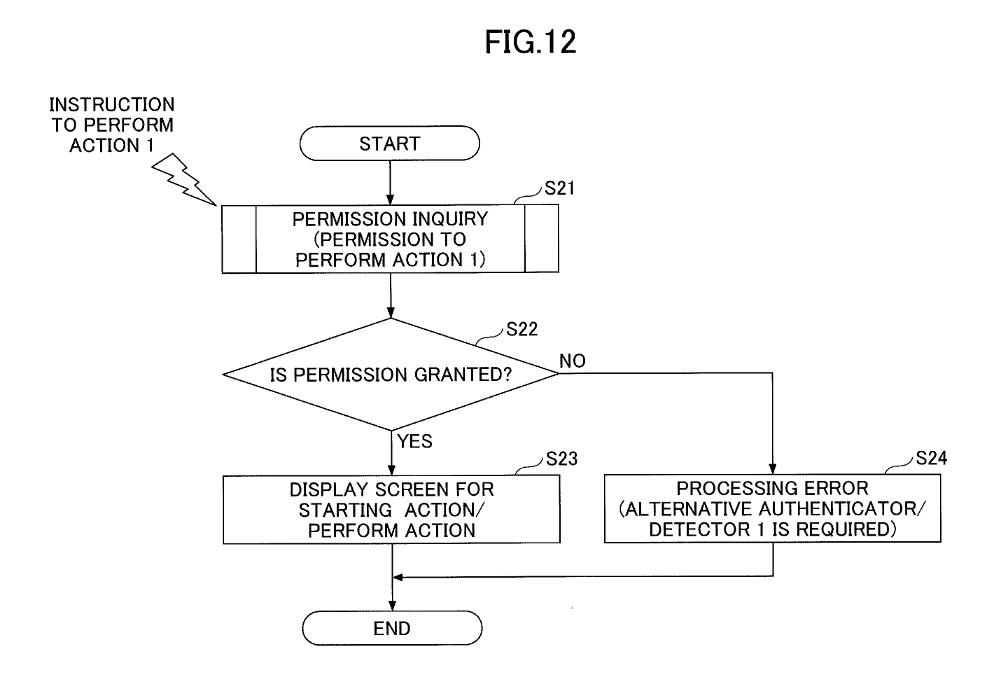

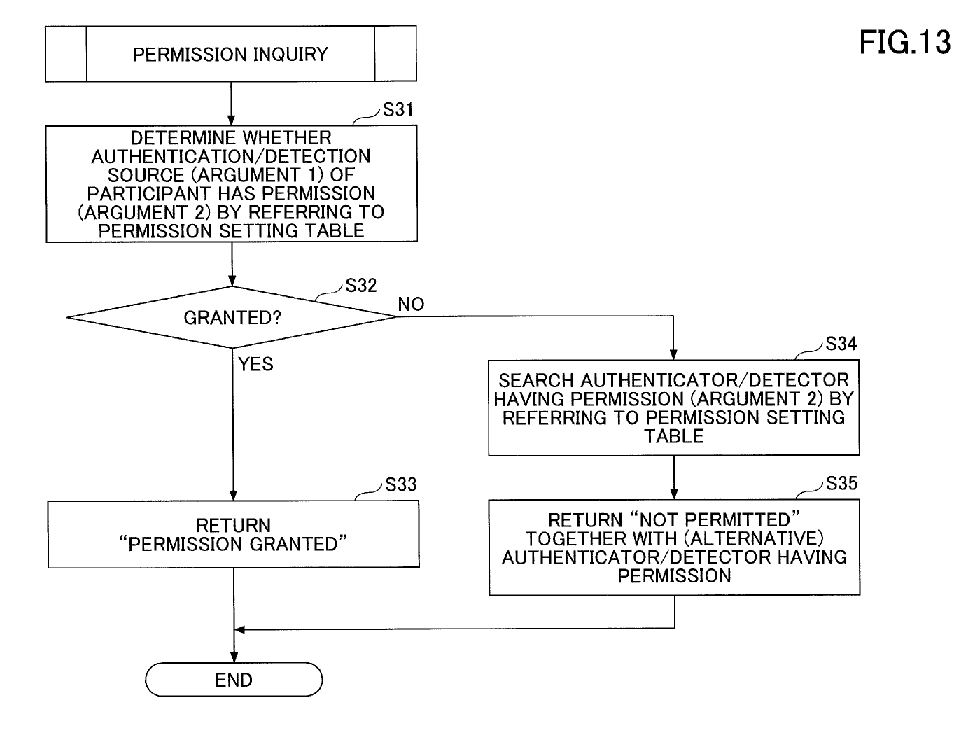

Further, the information processing system 1 according to the first embodiment performs a conference-related process by the following procedure, for example. FIG. 12 is a flowchart illustrating an exemplary conference-related process. FIG. 13 is a flowchart illustrating an exemplary permission inquiring process. In the following, an example in which the file loading unit 52 and the batch distribution unit 42 are regarded as a process executing unit will be described.

In response to receiving an instruction to perform an action, in step S21, the process executing unit requests the permission management unit 54 to perform a permission inquiring process illustrated in FIG. 13 so as to determine whether permission is granted. When the permission is granted, the process executing unit displays a screen for starting the action and performs the action in step S23. Conversely, when the permission is not granted, a processing error occurs in step S24. Note that when the permission management unit 54 returns an alternative authenticator/detector, the process executing unit may display a screen for prompting the participant to perform authentication by using the alternative authenticator/detector.

The permission inquiring process is performed by a procedure illustrated in FIG. 13. In step S31, the permission management unit 54 determines whether an authentication/detection source (argument 1) of the participant has the permission (argument 2) to perform the action by referring to the permission setting table on a per-authenticator/detector basis of FIG. 10. When the permission to perform the action, for which the instruction has been received, is “granted”, the permission management unit 54 returns “permission granted” to the process executing unit in step S33.

When the permission to perform the action, for which the instruction has been received, is not “granted”, the permission management unit 54 proceeds to step S34. In step S34, the permission management unit 54 searches an (alternative) authenticator/detector having the permission (argument 2) to perform the action, by referring to the permission setting table on a per-authenticator/detector basis of FIG. 10. In step S35, the permission management unit 54 returns “not permitted” to the process executing unit, together with the (alternative) authenticator/detector having the permission (argument 2) to perform the action.

In the information processing system 1 according to the first embodiment, the electronic whiteboard apparatus 14 is used in a conference by the following procedure, for example. In the following, an example will be described in which participants are registered in the electronic whiteboard apparatus 14 during a conference, a file owned by a participant is loaded and displayed on the electronic whiteboard apparatus 14, and a file containing contents displayed on the electronic whiteboard apparatus 14 is distributed to all conference participants.

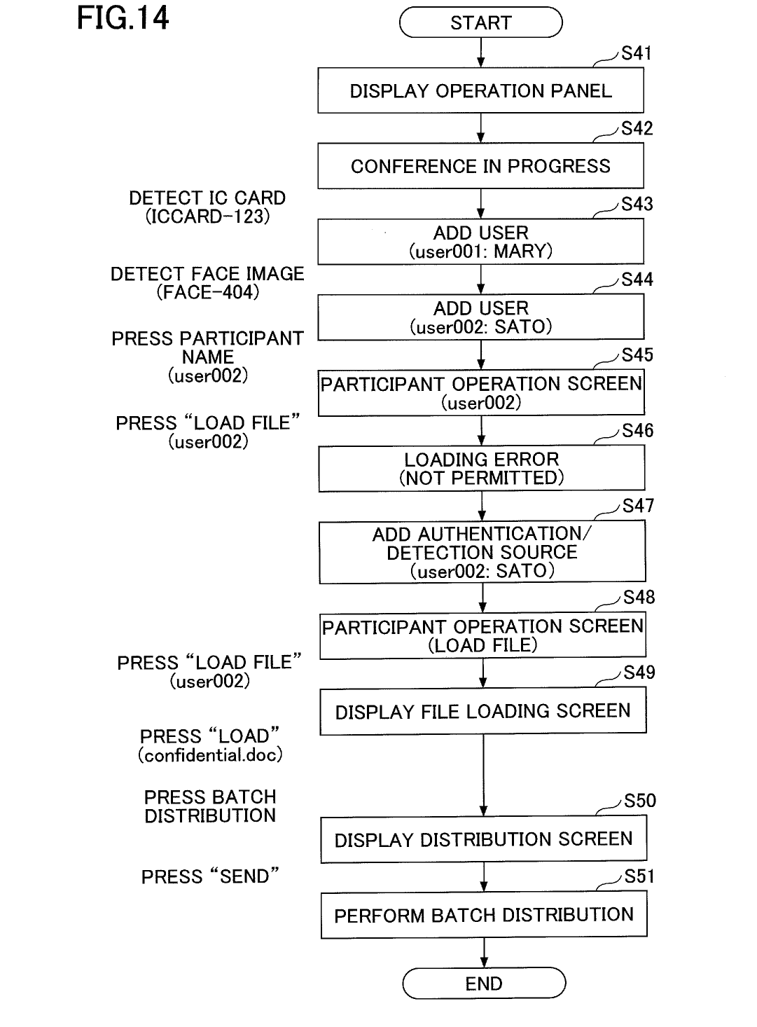

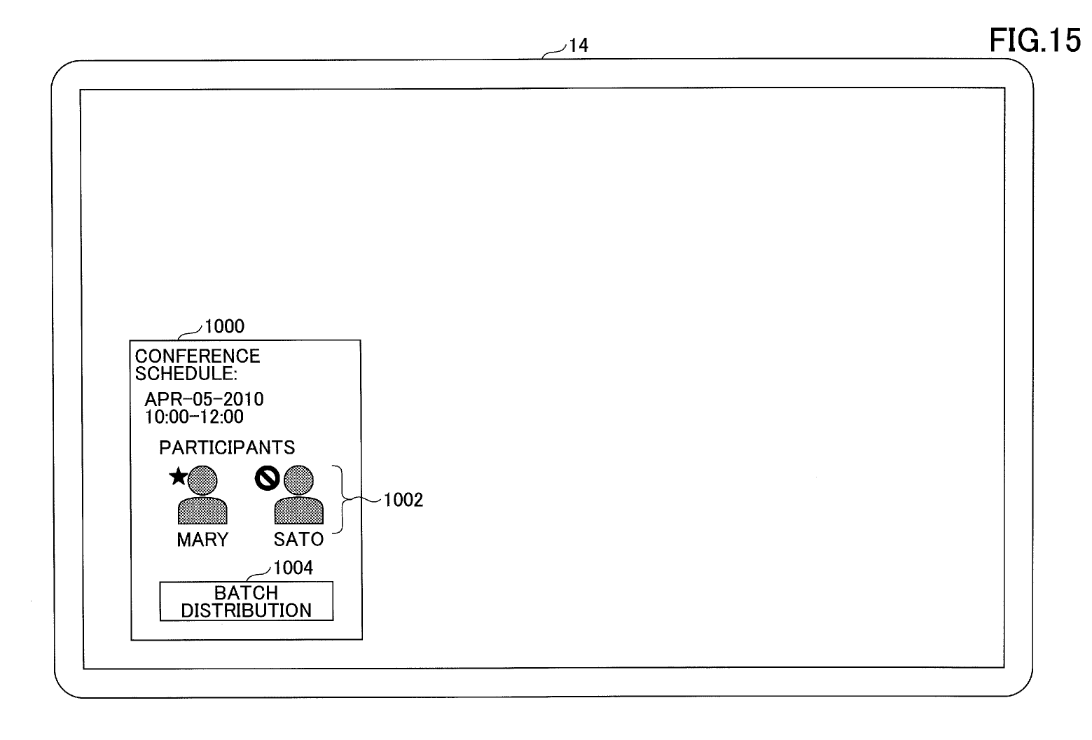

FIG. 14 is a flowchart illustrating an exemplary flow of a conference utilizing the electronic whiteboard apparatus 14. In step S41, the electronic whiteboard apparatus 14 displays an operation panel 1000 as illustrated in FIG. 15, for example, in response to an operation performed by a user who starts a conference. FIG. 15 is a diagram illustrating an exemplary operation panel displayed on the electronic whiteboard apparatus. The operation panel 1000 illustrated in FIG. 15 displays a list of participants 1002 and a “Batch Distribution” button 1004. The participants displayed in the list of participants 1002 are managed as conference participants, to which a file containing contents displayed on the electronic whiteboard apparatus 14 is distributed.

In step S42, during the conference, the electronic whiteboard apparatus 14 receives an operation such as writing to the electronic whiteboard apparatus 14, and updates contents displayed on the electronic whiteboard apparatus 14. When the IC card detecting unit 48 detects an IC card 630, the participant management unit 44 identifies a user based on identification information that has been read from the IC card 630, and adds the user to the participant management information list of FIG. 9 so as to manage the user as a conference participant, in step S43. Also, when the face image detecting unit 50 detects identification information from an image captured by the camera 618, the participant management unit 44 identifies a user based on the detected identification information, and adds the user to the participant management information list of FIG. 9 so as to manage the user as a conference participant, in step S44.

The conference participants added in steps S43 and S44 are included in the list of participants 1002 displayed on the operation panel 1000. As described above with reference to the permission setting table on a per-authenticator/detector basis of FIG. 10, actions that can be performed by participants differ depending on the authentication/detection source. Therefore, in the list of participants 1002 displayed on the operation panel 1000 of FIG. 15, a mark such as “★” indicating that an action can be performed may be placed at the upper left of a mark representing a person.

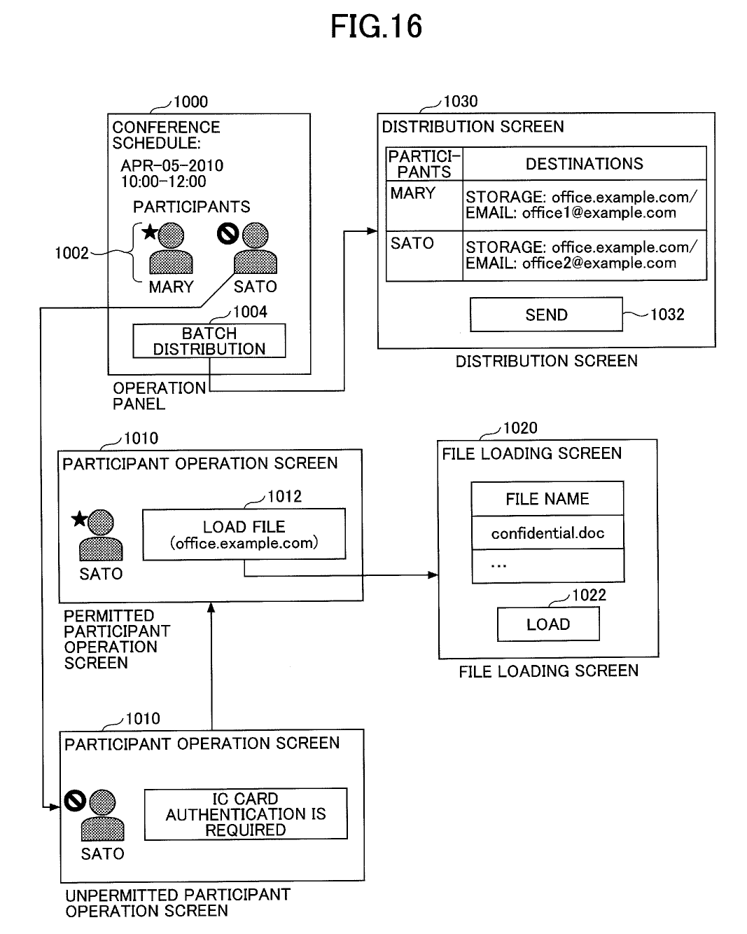

In response to an operation performed on the operation panel 1000, a user interface as illustrated in FIG. 16 is displayed on the electronic whiteboard apparatus 14. FIG. 16 is a diagram illustrating an exemplary user interface displayed on the electronic whiteboard apparatus in response to an operation performed on the operation panel 1000.

As illustrated in FIG. 16, upon the “Batch Distribution” button 1004 being pressed, a distribution screen 1030 is displayed on the electronic whiteboard apparatus 14. Destinations for each participant and a “Send” button 1032 are displayed on the distribution screen 1030. The participants can check the destinations from the distribution screen 1030. Also, by pressing the “Send” button 1032, the participants can cause the electronic whiteboard apparatus 14 to perform batch distribution of a file containing contents displayed on the electronic whiteboard apparatus 14.

Also, as illustrated in FIG. 16, when the electronic whiteboard apparatus 14 receives an operation for selecting, from the list of participants 1002, one participant without permission to load a file, the electronic whiteboard apparatus displays an unpermitted participant operation screen 1010. The unpermitted participant operation screen 1010 displays information indicating IC card authentication as an authenticator/detector to which the permission to load a file is granted. When the participant additionally performs the IC card authentication, the unpermitted participant operation screen 1010 transits to a permitted participant operation screen 1010. Also, when the electronic whiteboard apparatus 14 receives an operation for selecting, from the list of participants 1002, one participant with the permission to load a file, the electronic whiteboard apparatus 14 displays the permitted participant operation screen 1010.

As illustrated in FIG. 16, a “Load File” button 1012 is displayed on the permitted participant operation screen 1010. Upon the “Load File” button 1012 being pressed by the participant, a file loading screen 1020 can be displayed on the electronic whiteboard apparatus 14. The file loading screen 1020 displays a list of files that can be loaded with the permission granted to the participant who has been selected from the list of participants 1002, and also displays a “Load” button 1022. Upon the “Load” button 1022 being pressed, the participant can cause a file selected on the file loading screen 1020 to be loaded onto the electronic whiteboard apparatus 14.

For example, after step S44 of FIG. 14, when an operation for selecting a participant with a user ID “user002” is received, the file loading unit 52 displays the unpermitted participant operation screen 1010 based on the permission setting table on a per-authenticator/detector basis of FIG. 10 in steps S45 and S46.

In step S47, when the participant with the user ID “user002” additionally performs the IC card authentication, the screen transits to the permitted participant operation screen 1010. In step S48, upon the “Load File” button 1012 being pressed, the file loading unit 52 displays the file loading screen 1020. Upon the “Load” button 1022 being pressed, the file loading unit 52 loads a file with file name confidential.doc, which has been selected on the file loading screen 1020, from the storage service 32 onto the electronic whiteboard apparatus 14.

Further, upon the “Batch Distribution” button 1004 being pressed on the operation panel 1000, the batch distribution unit 42 displays the distribution screen 1030 in step S50. Upon the “Send” button 1032 being pressed, the batch distribution unit 42 puts contents being displayed on the electronic whiteboard apparatus 14 together into a file, and distributes the file to all the destinations set on a per-participant basis.

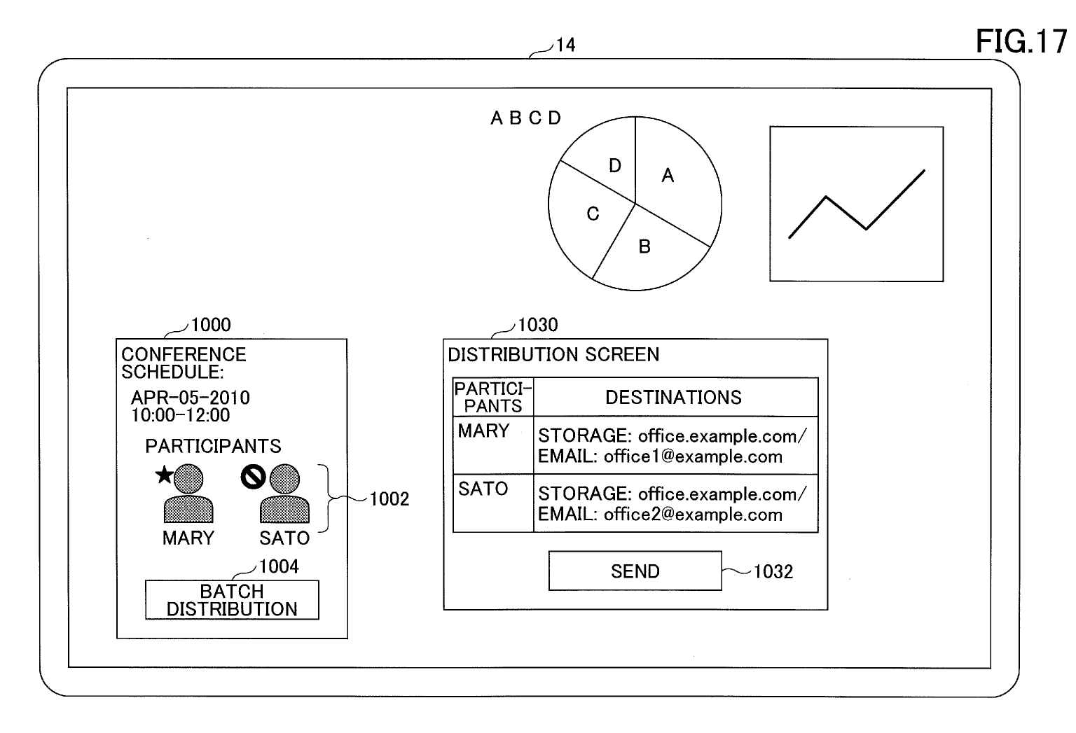

For example, the distribution screen 1030 illustrated in FIG. 16 is displayed on the electronic whiteboard apparatus 14 as illustrated in FIG. 17. FIG. 17 is a diagram illustrating an exemplary distribution screen displayed on the electronic whiteboard apparatus in response to an operation being performed on the operation panel. As illustrated in FIG. 17, the distribution screen 1030 may be displayed next to the operation panel 1000, or may be displayed after the operation panel 1000 is hidden.

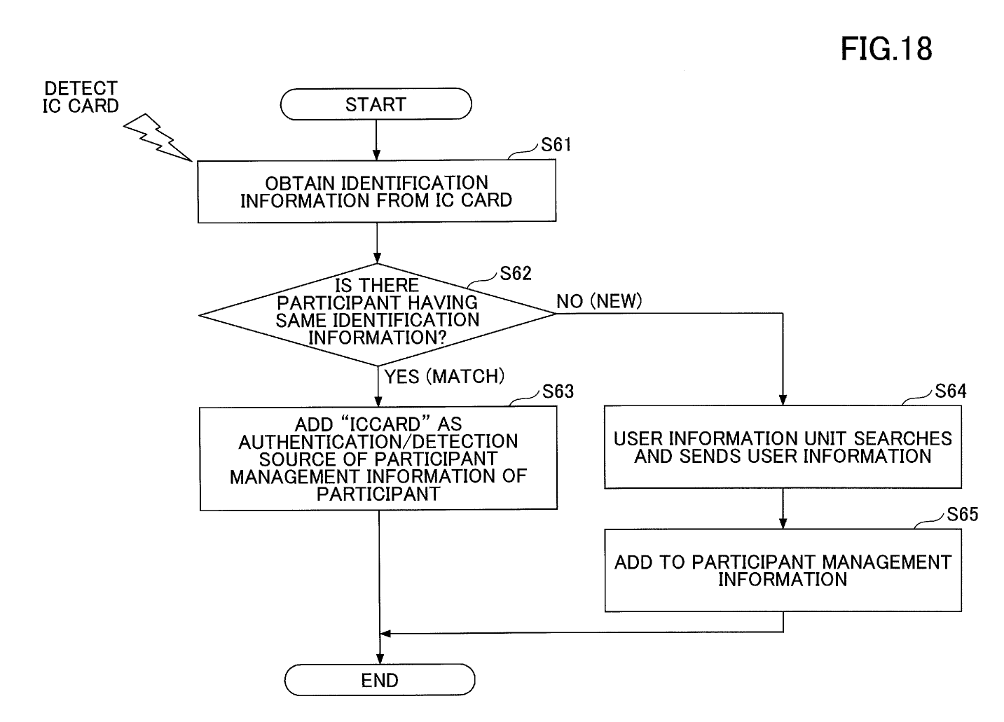

For example, in step S43 of FIG. 14, the conference participant is added by performing the IC card authentication by using a procedure of FIG. 18. FIG. 18 is a flowchart illustrating an exemplary conference participant adding process. FIG. 18 illustrates a process performed after the IC card detecting unit 48 has detected the IC card 630 and read the identification information from the IC card 630.

In step S61, the participant management unit 44 obtains the identification information read from the IC card 630. In step S62, the participant management unit 44 determines whether a user having the same identification information is included in the participant management information list by referring to the user information list.

When the participant management information list includes a user having the same identification information, the participant management unit 44 proceeds to step S63. In step S63, the participant management unit 44 adds “ICCARD”, which indicates the IC card detecting unit 48 that has detected the identification information, as an authentication/detection source of the participant management information list of FIG. 9 in association with the participant corresponding to the identification information detected in step S61.

When the participant management information list does not include a user having the identification information, the participant management unit 44 proceeds to step S64. In step S64, the participant management unit 44 requests the user information unit 22 to search user information by using the identification information obtained in step S61. The participant management unit 44 obtains user information corresponding to the identification information obtained in step S61, from the user information unit 22 as a response to the request for search.

In step S65, the participant management unit 44 adds, to the participant management information list of FIG. 9, participant management information in which a user ID included in the user information obtained as the response in step S64 is associated with “ICCARD”, which indicates the IC card detecting unit 48 that has detected the identification information.

For example, when the IC card detecting unit 48 detects the IC card 630 of “Mary Smith” illustrated in the user information list of FIG. 7, the IC card detecting unit 48 reads identification information “ICCARD-123.” In step S61, the participant management unit 44 obtains the identification information “ICCARD-123” from the IC card detecting unit 48.

In step S62, the participant management 44 determines whether a user having the same identification information as the identification information “ICCARD-123” obtained in step S61 is included in the participant management information list by referring to the user information list of FIG. 7. In the following example, it is assumed that a user having the same identification information is not included in the participant management information list.

Because it is determined that a user having the same identification information is not included, the participant management unit 44 proceeds to step S64 and requests the user information unit 22 to search user information by using the identification information “ICCARD-123” obtained in step S61. The participant management unit 44 obtains user information corresponding to the identification information “ICCARD-123” obtained in step S61, from the user information unit 22 as a response to the request for search.

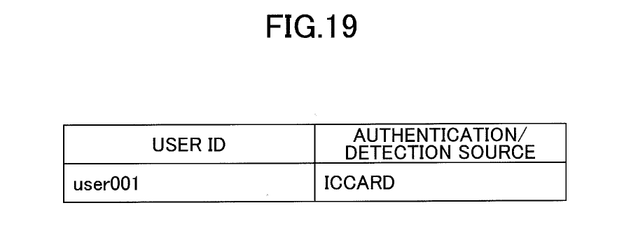

In step S65, as illustrated in FIG. 19, the participant management unit 44 adds, to the participant management information list, participant management information in which a user ID “user001” included in the user information obtained as the response in step S64 is associated with “ICCARD”, which indicates the IC card detecting unit 48 that has detected the identification information. FIG. 19 is a diagram illustrating an exemplary participant management information list after a participant is added.

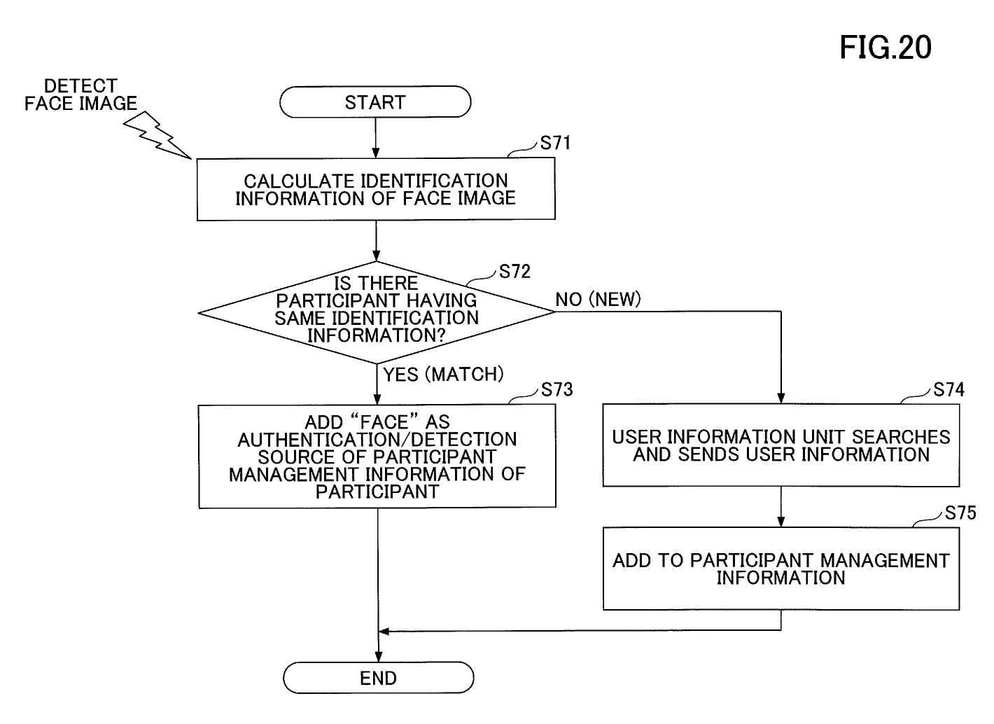

For example, in step S44 of FIG. 14, the conference participant is added by the face authentication by using a procedure illustrated in FIG. 20. FIG. 20 is a flowchart illustrating another exemplary conference participant adding process. FIG. 20 illustrates a process performed after the face image detecting unit 50 has detected the face region of the user from the image captured by the camera 618 during the conference.

In step S71, the face image detecting unit 50 calculates identification information of the face image from the face region of the detected user. In step S72, the participant management unit 44 determines whether a user having the same identification information is included in the participant management information list by referring to the user information list of FIG. 7.

When the participant management information list includes a user having the same identification information, the participant management unit 44 proceeds to step S73. In step S73, the participant management unit 44 adds “FACE”, which indicates the face image detecting unit 50 that has detected the identification information, as an authentication/detection source of the participant management information list of FIG. 9 in association with the participant corresponding to the identification information detected in step S71.

When the participant management information list does not include a user having the identification information, the participant management unit 44 proceeds to step S74. In step S74, the participant management unit 44 requests the user information unit 22 to search user information by using the identification information obtained in step S71. The participant management unit 44 obtains user information corresponding to the identification information obtained in step S71, from the user information unit 22 as a response to the request for search. In step S75, the participant management unit 44 adds, to the participant management information list of FIG. 9, participant management information in which a user ID included in the user information obtained as the response in step S74 is associated with “FACE”, which indicates the face image detecting unit 50 that has detected the identification information.

For example, when the camera 618 captures an image of “Sato Suzuki” illustrated in the user information list of FIG. 7, the face image detecting unit 50 of the electronic whiteboard apparatus 14 detects a face region from the image captured by the camera 618. The face image detecting unit 5 calculates identification information “FACE-404” of the face image from the face region of the detected user. The participant management unit 44 obtains the identification information “FACE-404” from the face image detecting unit 50.

In step S72, the participant management unit 44 determines whether a user having the same identification information as the identification information “FACE-404” obtained in step S71 is included in the participant management information list by referring to the user information list of FIG. 7. In the following example, it is assumed that a user having the same identification information is not included in the participant management information list.

Because it is determined that a user having the same identification information is not included, the participant management unit 44 proceeds to step S74 and requests the user information unit 22 to search user information by using the identification information “FACE-404” obtained in step S71. The participant management unit 44 obtains user information corresponding to the identification information “FACE-404”, from the user information unit 22 as a response to the request for search.

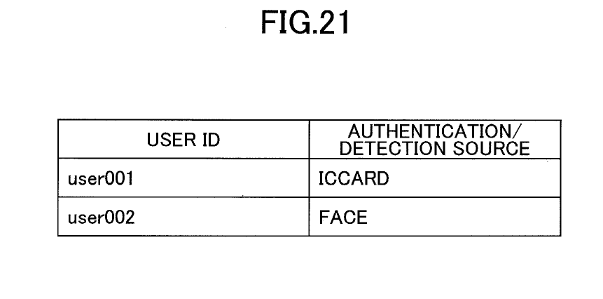

In step S75, as illustrated in FIG. 21, the participant management unit 44 adds, to the participant management information list, participant management information in which a user ID “user002” included in the user information obtained as the response in step S74 is associated with “FACE”, which indicates the face image detecting unit 50 that has detected the identification information. FIG. 21 is a diagram illustrating another exemplary participant management information list after a participant is added.

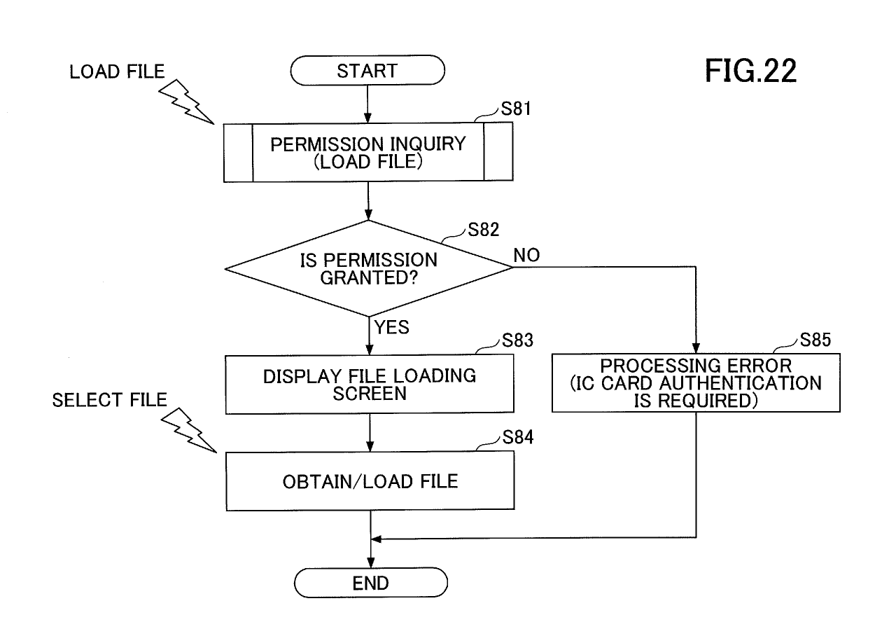

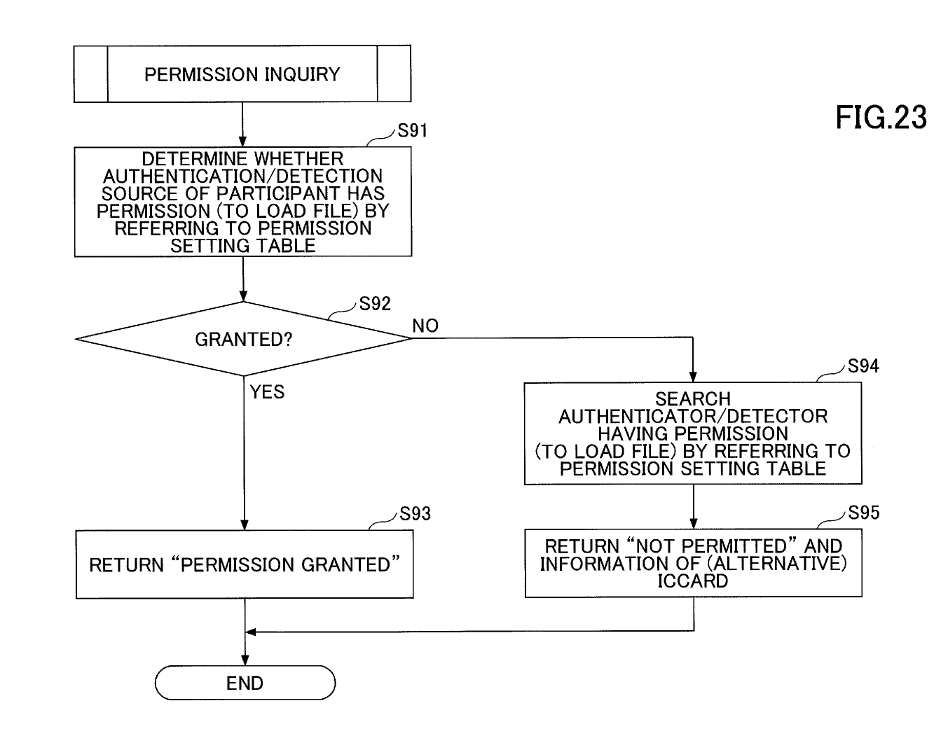

For example, in steps S45 and S46 of FIG. 14, a file loading process is performed by a procedure illustrated in FIG. 22. FIG. 22 is a flowchart illustrating an exemplary file loading process. FIG. 23 is a flowchart illustrating another exemplary permission inquiring process.

In response to receiving an instruction to load a file, the file loading unit 52 proceeds to step S81 and requests the permission management unit 54 to determine whether the permission to perform the “Load File” action is granted by performing the permission inquiring process illustrated in FIG. 23. When the permission is granted, the file loading unit 52 displays the file loading screen 1020 in step S83. In step S84, upon the “Load File” button 1012 being pressed, the file is loaded. Conversely, when the permission is not granted, a processing error occurs in step S85, and the file loading unit 52 displays the unpermitted participant operation screen 1010.

The permission inquiring process in step 81 is performed by a procedure illustrated in FIG. 23. In step S91, the permission management unit 54 determines whether the authentication/detection source (argument 1) of the participant has the permission (argument 2) to perform the “Load File” action by referring to the permission setting table on a per-authenticator/detector basis of FIG. 10. When the permission to perform the “Load File” action is “granted”, the permission management unit 54 returns “permission granted” to the process executing unit in step S93.

When the permission to perform the “Load File” action is not “granted”, the permission management unit 54 proceeds to step S94. In step S94, the permission management unit 54 searches the authenticator/detector (ICCARD) having the permission (argument 2) to perform the “Load File” action, by referring to the permission setting table on a per-authenticator/detector basis of FIG. 10. In step S95, the permission management unit 54 returns “not permitted” to the file loading unit 52, together with information of the authenticator/detector (ICCARD) having the permission (argument 2) to perform the “Load File” action to the file loading unit 52.

For example, in order to additionally load a file owned by the participant with the user ID “user002” from the storage service 32, the participant instructs the file loading unit 52 to start loading the file. In response to receiving the instruction to start loading the file, the file loading unit 52 specifies the authentication/detection source “FACE” by referring to the participant management information held by the participant management unit 44 and also the “Load File” action, so as to request the permission management unit 54 to determine whether the permission is granted.

The permission management unit 54 checks the permission setting table on a per-authenticator/detector basis of FIG. 10 and determines that the permission to perform the “Load File” action is not applicable (N/A) to the authenticator/detector “FACE”. Because the permission to perform the “Load File” action, for which the instruction has been received, is not granted, the permission management unit 54 returns “not permitted” to the file loading unit 52, together with information of the authentication/detection source “ICCARD” to which the permission to perform the “Load File” action is granted. The file loading unit 52 displays the unpermitted participant operation screen 1010 for promoting the user to perform the IC card authentication.

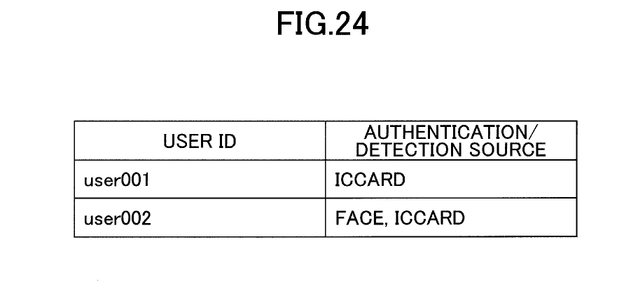

Next, the participant with the user ID “user002” performs the IC card authentication by using his/her own IC card 630. For example, the procedure illustrated in FIG. 18 is performed such that “ICCARD” indicating the IC card detecting unit 48 is added as an authentication/detection source of the participant management information in association with the user ID “user002”, as illustrated in FIG. 24.

Again, in order to additionally load the file owned by the participant with the user ID “user002” from the storage service 32, the participant instructs the file loading unit 52 to start loading the file. In response to receiving the instruction to start loading the file, the file loading unit 52 specifies the authentication/detection sources “FACE” and “ICCARD” by referring to the participant management information of the user ID “user002” held by the participant management unit 44 and also specifies the “Load File” action, so as to request the permission management unit 54 to determine whether the permission is granted.

The permission management unit 54 checks the permission setting table on a per-authenticator/detector basis of FIG. 10 and determines that the permission to perform the “Load File” action is granted to the authenticator/detector “ICCARD”. Because the permission to perform the “Load File” action, for which the instruction has been received, is granted, the permission management unit 54 returns “permission granted” to the file loading unit 52. In response to receiving “permission granted”, the file loading unit 52 displays the file loading screen 1020, for example. Upon the “Load” button 1022 being pressed, the file loading unit 52 uses external service setting information of an external service setting ID “connect2a” so as to load a “confidential.doc” file from the storage service 32 and display the file on the electronic whiteboard apparatus 14.

As described above, the electronic whiteboard apparatus 14 verifies an authentication and detection source of a participant with the permission setting table on a per-authenticator/detector basis. Accordingly, when an authenticator/detector is unreliable, for example, when the accuracy of an authenticator/detector is low, it becomes possible to restrict files from being loaded from the storage service 32, thus preventing information leakage. Also, when file loading from the storage service 32 is restricted, a participant is provided with notification of an alternative authenticator/detector such that restrictions on file loading from the storage service 32 can be removed. Accordingly, it becomes possible to readily remove restrictions on file loading from the storage service 32.

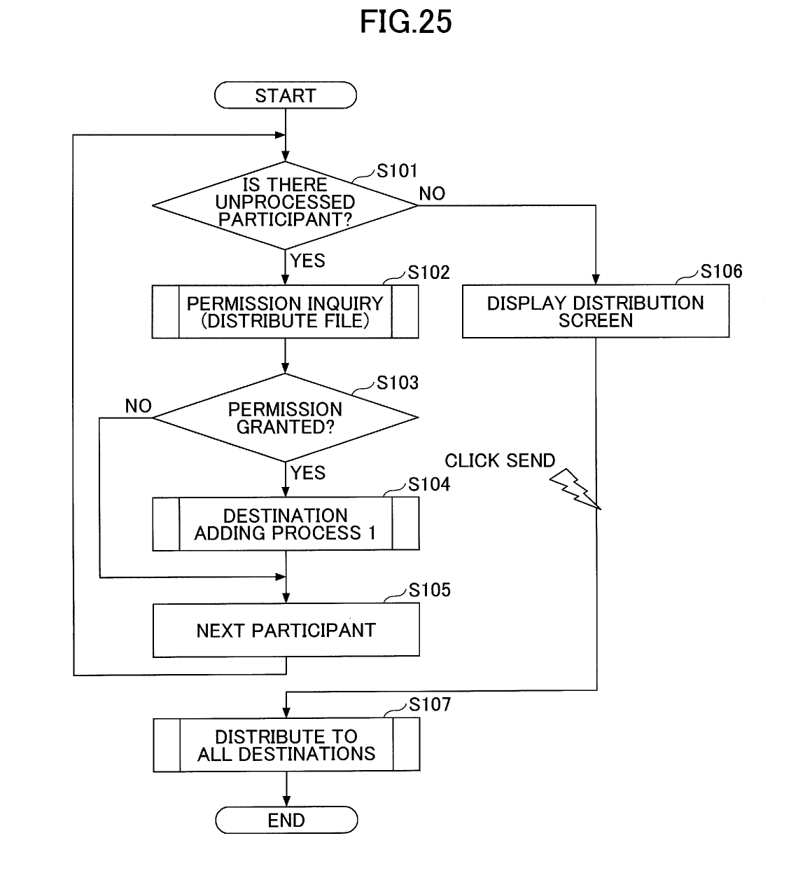

For example, in steps S50 and S51 of FIG. 14, batch distribution of the file containing the contents being displayed on the electronic whiteboard apparatus 14 is performed by a procedure illustrated in FIG. 25. FIG. 25 is a flowchart illustrating an exemplary batch distribution process.

Upon the “Batch Distribution” button 1004 being pressed, in steps S101 through S105, the batch distribution unit 42 performs the permission inquiring process of step S102 for all participants managed in the participant management information list obtained from the participant management unit 44, and performs a destination adding process of step S104 for participants having the permission.

After steps S101 through S105 are performed for all the participants, the batch distribution unit 42 displays the distribution screen 1030 in step S106. Upon the “Send” button 1032 being pressed, the batch distribution unit 42 proceeds to step S107 and performs a process for distributing the file containing the contents displayed on the electronic whiteboard apparatus 14 to all destinations, which have been associated with the participants as a result of the destination adding process of step S104.

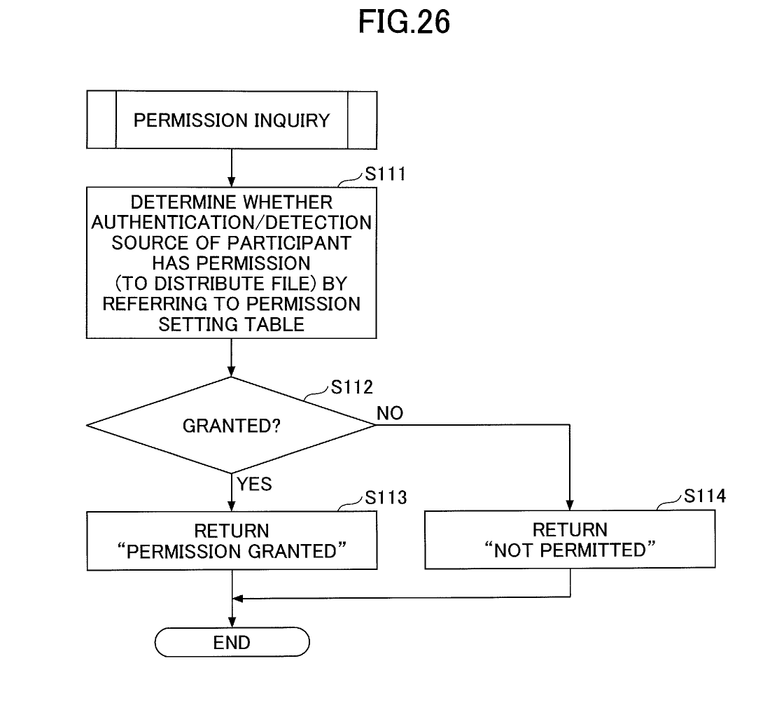

For example, in step S102 of FIG. 25, the permission inquiring process is performed by a procedure illustrated in FIG. 26. FIG. 26 is a flowchart illustrating another exemplary permission inquiring process. The permission inquiring process illustrated in FIG. 26 is performed for all participants included in the participant management information list.

In step S111, the permission management unit 54 determines whether an authentication/detection source of a participant has the permission to perform the “distribute files” action by referring to the permission setting table on a per-authenticator/detector basis illustrated in FIG. 10. When the permission to perform the “distribute files” action is “granted”, the permission management unit 54 returns “permission granted” to the batch distribution unit 42 in step S113. When the permission to perform the “distribute files” action is not “granted”, the permission management unit 54 returns “not permitted” to the batch distribution unit 42 in step S114.

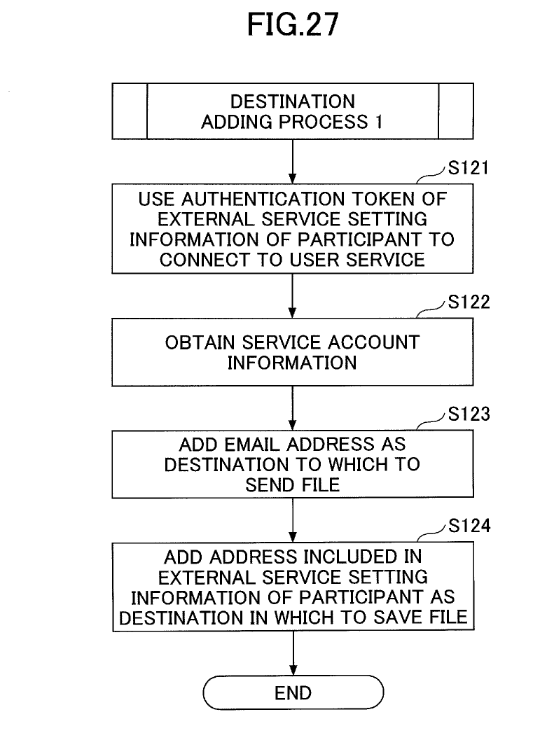

For example, in step S104 of FIG. 25, the destination adding process is performed by a procedure illustrated in FIG. 27. FIG. 27 is a flowchart illustrating an exemplary destination adding process. The destination adding process illustrated in FIG. 27 is performed for all participants included in the participant management information list and also having the permission to perform the “Load File” action.

In step S121, the batch distribution unit 42 uses an external service authentication token of external service setting information of a participant illustrated in FIG. 8 to connect to the user service 30. In step S122, the batch distribution unit 42 obtains user service account information of the participant from the user service 30.

In step S123, the batch distribution unit 42 adds an email address included in the user service account information as a destination to which to send the file. In step S124, the batch distribution unit 42 adds an address included in the external service setting information as a destination in which to save the file.

In the following, steps S101 through S105 will be described in detail by taking, as an example, the user information list of FIG. 7 and the external service setting information of FIG. 8, the participant management information list of FIG. 9, and the permission setting table on a per-authenticator/detector basis of FIG. 10.

The batch distribution unit 42 performs the batch distribution process for each of the two participants with the user IDs “user001” and “user002”. For the participant with the user ID “user001”, the batch distribution unit 42 specifies the authentication/detection source “ICCARD” of the user ID “user001”, which is included in the participant management information obtained from the participant management unit 44, and also specifies the “Load File” action, so as to cause the permission management unit 54 to perform the permission inquiry process.

The permission management unit 54 determines that the permission to perform the “Load File” action is granted to the authentication/detection source “ICCARD” by referring to the permission setting table on a per-authenticator/detector basis illustrated in FIG. 10, and returns “permission granted” to the batch distribution unit 42. In response to receiving “permission granted”, the batch distribution unit 42 performs the destination adding process in step S104.

The batch distribution unit 42 requests the external service setting information unit 20 to obtain user service account information of the participant with the user ID “user001”. The external service setting information unit 20 uses an external service authentication token “eyJhbGc11”, which differs for each participant, to requests the user service 30 of the address information “office.example.com” to obtain user service account information of an external service user ID “office1”. As a result, an email address “office1@office.example.com” is obtained. The batch distribution unit 42 adds the obtained email address “office1@office.example.com” as a destination, to which the file is sent, of the participant with user ID “user001”.

Also, the batch distribution unit 42 adds the address information “office.example.com” included in the external service setting information of the user ID “user001” as a destination, in which the file is saved, of the participant.

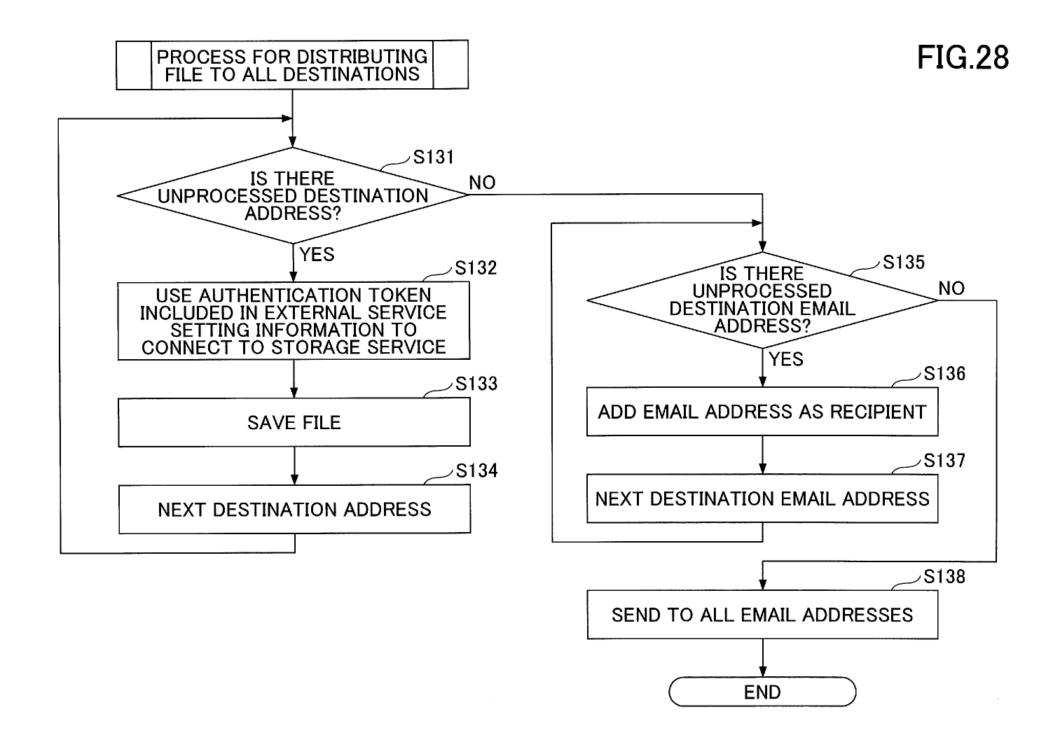

In step S107 of FIG. 25, a process for distributing a file to all destinations will be performed by a procedure illustrated in FIG. 28. FIG. 28 is a flowchart illustrating an exemplary process for distributing a file to all destinations. In the process of FIG. 28, the file containing the contents being displayed on the electronic whiteboard apparatus 14 is distributed to all destinations, which have been associated with the participants as a result of the destination adding process of FIG. 25.

The batch distribution unit 42 repeatedly performs steps S131 through S134 for all the destinations, which have been added as destinations displayed on the distribution screen 1030 as a result of the destination adding process of FIG. 25. In step S132, the batch distribution unit 42 connects to the storage service 32 of the external service group system 12 by using an external service authentication token included in external service setting information associated with an unprocessed destination. In step S133, the batch distribution unit 42 stores the file containing the contents displayed on the electronic whiteboard apparatus 14 in the destination of the connected storage service 32.

After the batch distribution unit 42 stores the file in all the destinations, which have been added as destinations displayed on the distribution screen 1030 as a result of the destination adding process of FIG. 25, the distribution unit 42 proceeds to step S135. The batch distribution unit 42 performs steps S135 through 5137 for all email addresses, which have been added as destinations displayed on the distribution screen 1030 as a result of the destination adding process of FIG. 25. Accordingly, the email addresses are added as a destination (To:) of an email from which to send the file containing the contents displayed on the electronic whiteboard apparatus 14.

In step S138, the batch distribution unit 42 sends the email with the file containing the contents displayed on the electronic whiteboard apparatus 14, to all the email addresses added as destinations displayed on the distribution screen 1030.

As described, in the process for sending a file to all destinations illustrated in FIG. 28, the file can be stored in all the destinations, which are different for each participant, of the storage service 32 of the external service group system 12, and can be also sent to all the email addresses of the user service 30.

According to the first embodiment, when a file containing contents being displayed on the electronic whiteboard apparatus 14 is distributed to a conference participant, an action to be performed by the participant can be restricted in accordance with an authenticator/detector that has authenticated the participant.

### Second Embodiment

The external service group system 12 according to the first embodiment may include a schedule service. The schedule service manages activity schedules and conference schedules of users. Such a schedule service has conference schedule information such as prospective conference participants.

In the second embodiment, prospective conference participants are set in the schedule service of the external service group system, an a conference schedule to be attended by the prospective conference participants is regarded as an authentication/detection source of a permission setting table on a per-authenticator/detector basis.

Based on the permission setting table on a per-authenticator/detector basis, actions such as file loading are restricted. Also, in the second embodiment, the prospective participants are subjected to the batch distribution process.

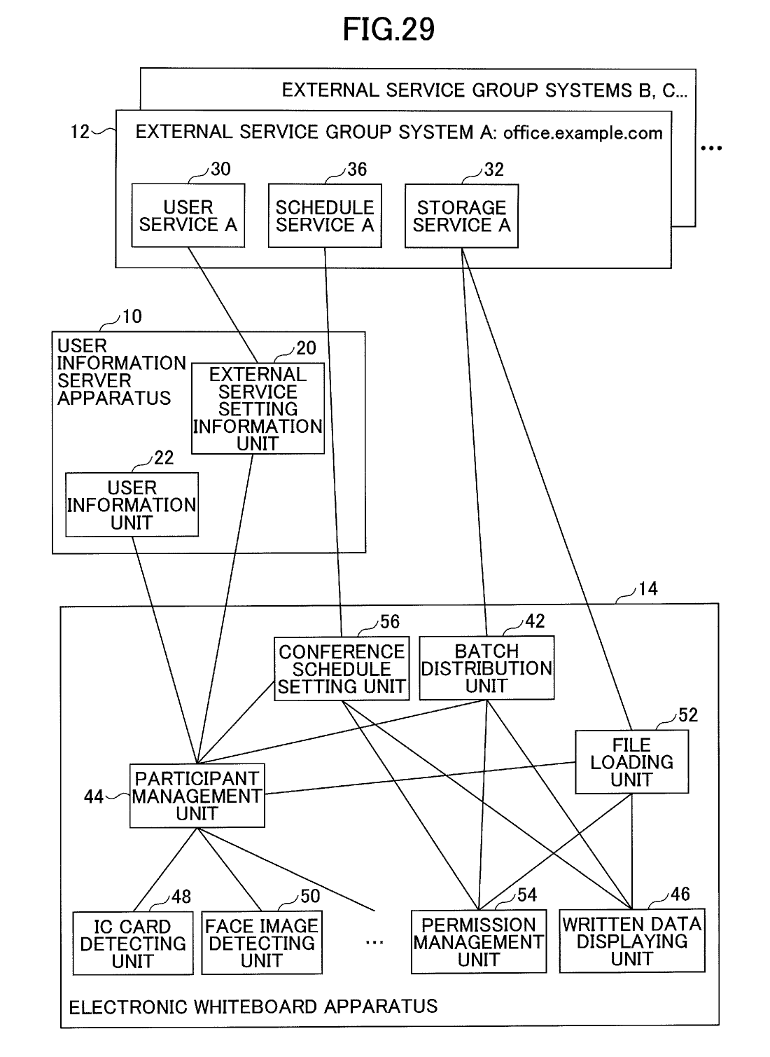

FIG. 29 is a diagram illustrating an exemplary functional configuration of an information processing system according to the second embodiment. The functional configuration of FIG. 29 is a functional configuration in which a schedule service 36 and a conference schedule setting unit 56 are added to the functional configuration of FIG. 4. The schedule service 36 is added to the external service group system 12. The conference schedule setting unit 56 is added to the electronic whiteboard apparatus 14.

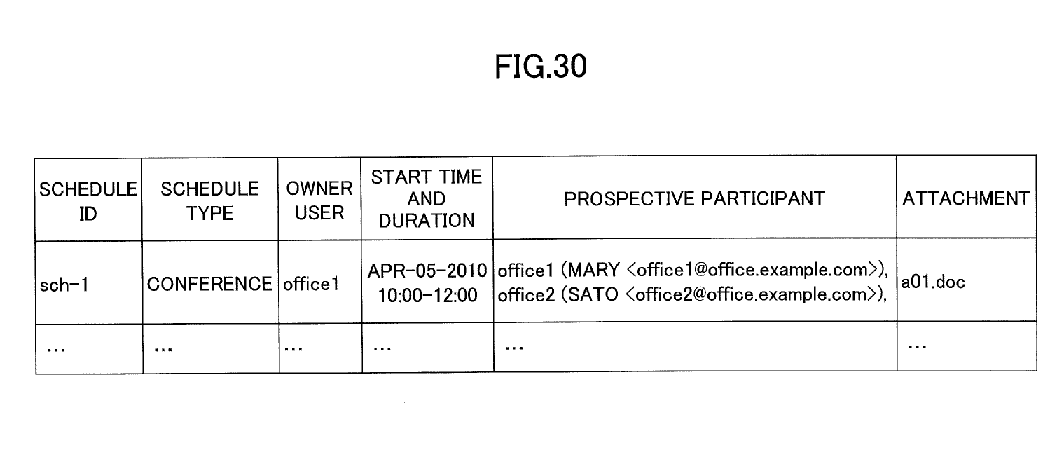

The schedule service 36 includes schedule information as illustrated in FIG. 30, for example. FIG. 30 is a diagram illustrating exemplary schedule information according to the second embodiment. As illustrated in FIG. 30, the schedule service 36 includes, as schedule information, “schedule ID”, “schedule type”, “owner user”, “start time and duration”, “prospective participant”, and “attachment”. In the schedule information illustrated in FIG. 30, a user's activity schedule information and conference schedule information can be distinguished by the schedule type.

The conference schedule setting unit 56 of the electronic whiteboard apparatus 14 includes a user interface for setting a conference schedule, communicates with the schedule service 36 of the external service group system 12, and displays schedule information whose schedule type is “conference”, and causes a user to select a conference schedule.

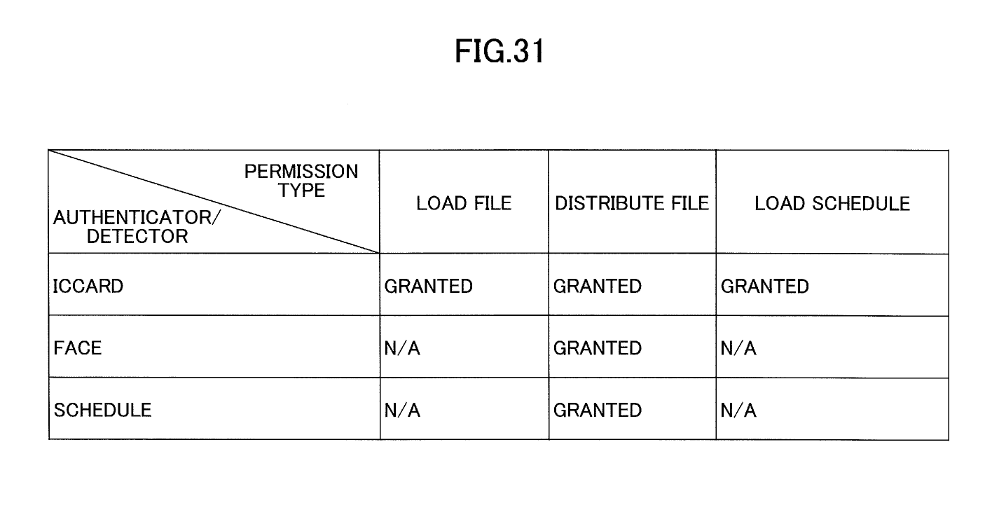

Also, in the second embodiment, a permission setting table on a per-authenticator/detector basis as illustrated in FIG. 31 is used. FIG. 31 is a diagram illustrating an exemplary permission setting table on a per-authenticator/detector basis according to the second embodiment.

The permission setting table on a per-authenticator/detector basis of FIG. 31 has a configuration in which an authenticator/detector “SCHEDULE” and a permission type “Load Schedule” are added to the permission setting table on a per-authenticator/detector basis of FIG. 10. For example, the authenticator/detector “SCHEDULE” of FIG. 31 is an authenticator/detector set to a prospective conference participant. In the permission setting table on a per-authenticator/detector basis of FIG. 31, a participant set as a prospective conference participant has the permission to distribute a file.

Briefly, in the second embodiment, a participant who is detected first after the start of a conference is regarded as a leader by the conference schedule setting unit 56. If the participant is an owner user and has the permission to “Load Schedule”, the conference schedule setting unit 56 obtains conference schedule information.

The conference schedule setting unit 56 presents a list of conference schedules to the user based on the obtained conference schedule information. When the user selects a conference from the list of conference schedules, the conference schedule setting unit 56 reads and displays an attachment for the conference. Further, the participant management unit 44 adds prospective conference participants to a list of participants 1002 of the operation panel 1000, adds the prospective conference participants to a participant management information list, and “SCHEDULE” is set as their authentication/detection sources. Because the conference leader can freely set prospective conference participants, the prospective conference participants are added to the participant management information list as participants only having the permission to distribute a file. Accordingly, in the second embodiment, even when prospective conference participants are treated as conference participants in conjunction with the schedule service 36 of the external service group system 12, it becomes possible to reduce security risks such as illegally loading files.

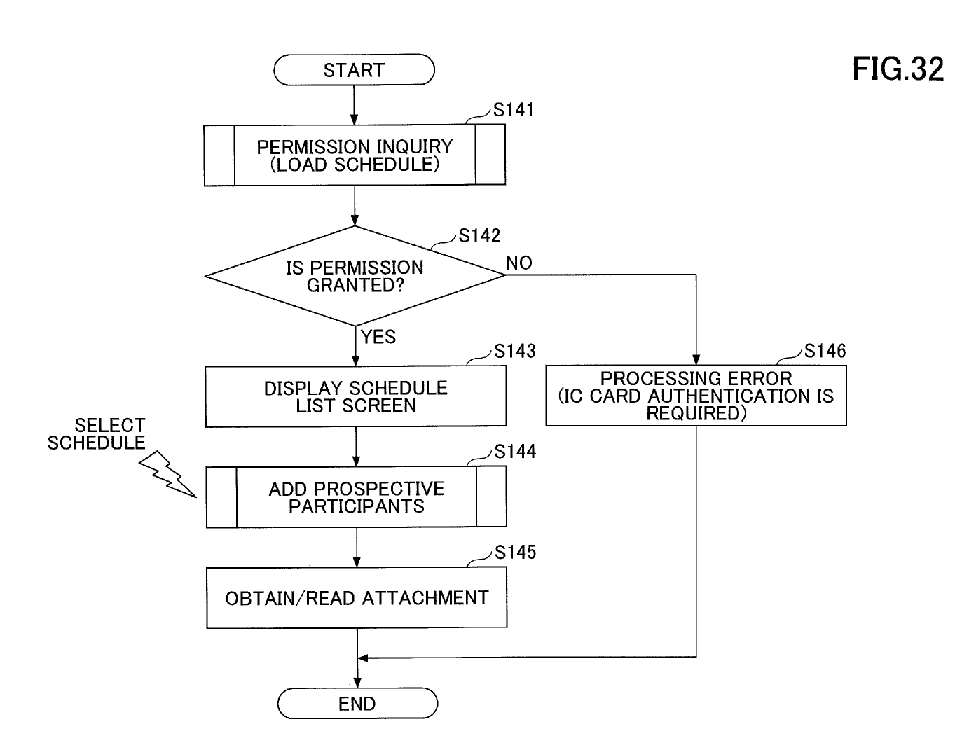

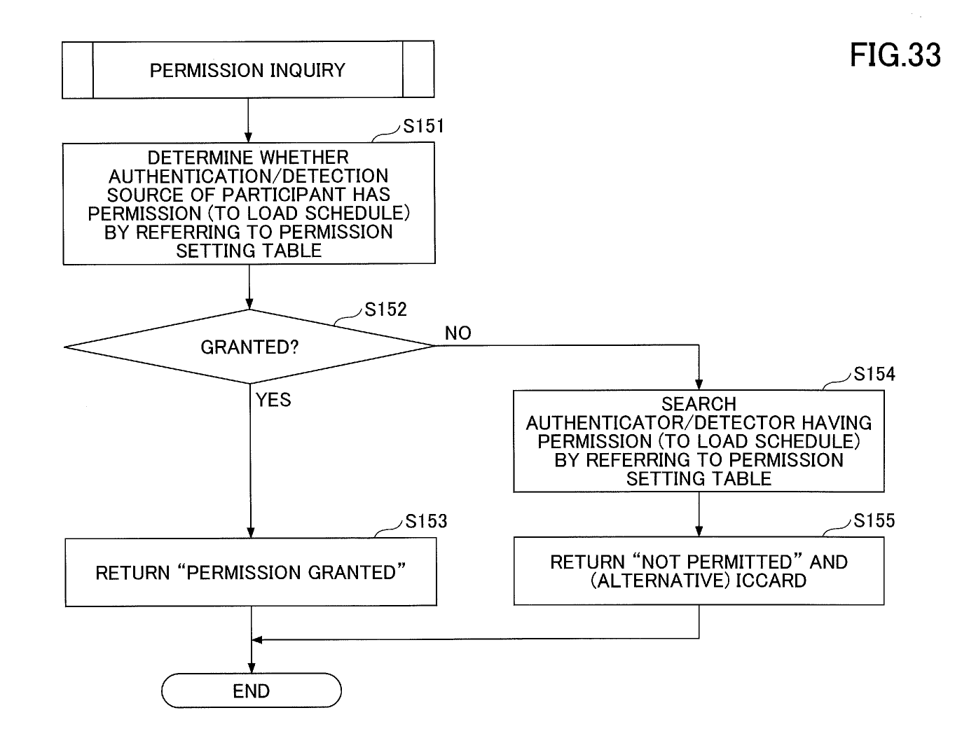

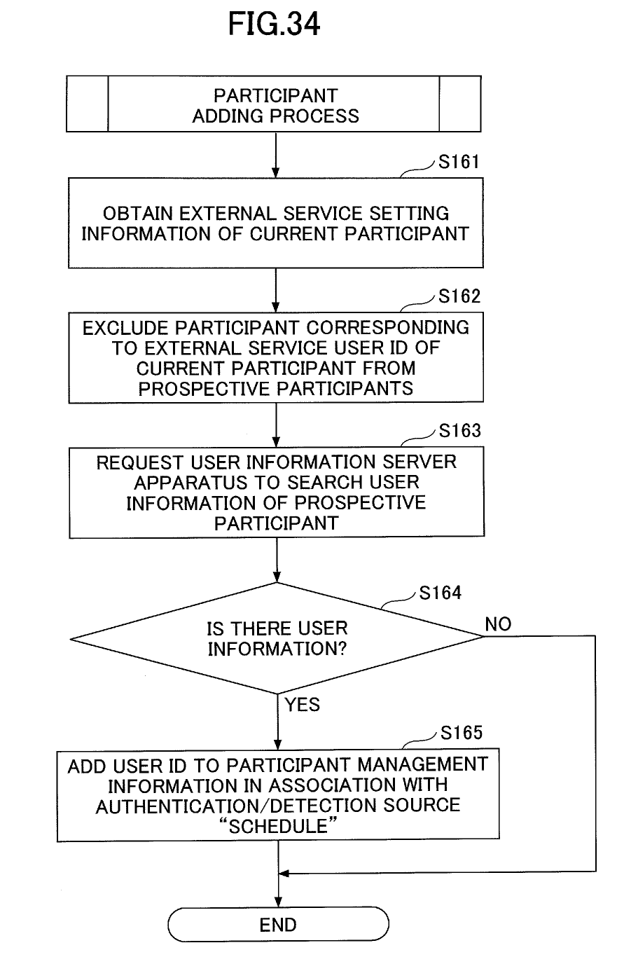

FIG. 32 is a flowchart illustrating an exemplary conference schedule setting process according to the second embodiment. FIG. 33 is a flowchart illustrating an exemplary permission inquiring process according to the second embodiment. FIG. 34 is a flowchart illustrating an exemplary prospective participant adding process according to the second embodiment.

In the example of the conference schedule setting process of FIG. 32, when the conference schedule setting unit 56 detects a first participant, the conference schedule setting unit 56 adds prospective conference participants to participant management information as conference participants, based on schedule information in which the detected first participant is set as an owner user.

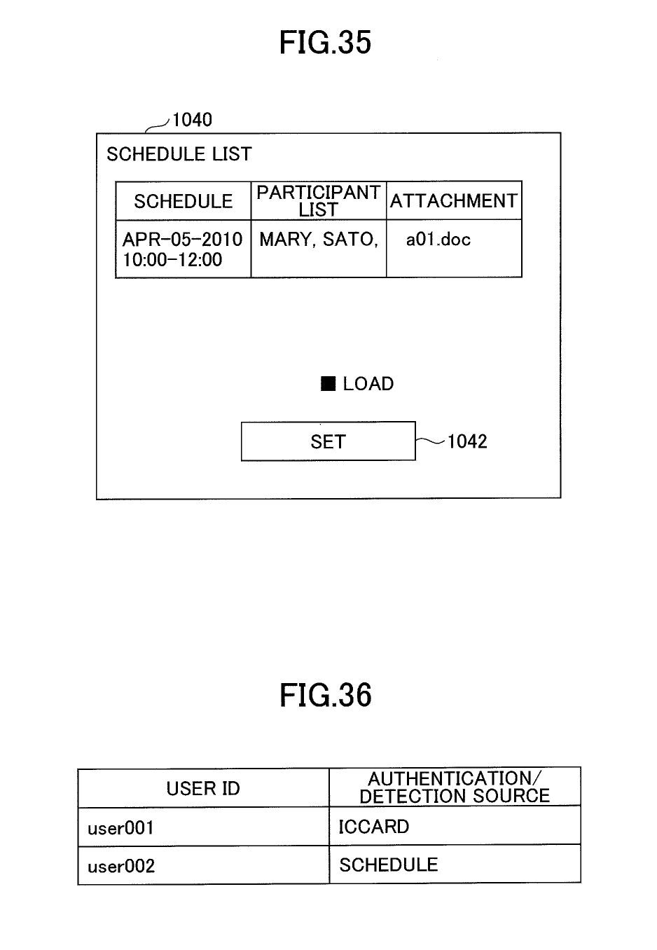

In step S141, in response to receiving an instruction to load a schedule, the conference schedule setting unit 56 requests the permission management unit 54 to perform the permission inquiring process illustrated in FIG. 33 so as to determine whether the permission to perform the “Load Schedule” action is granted. When it is determined the permission is granted, the conference schedule setting unit 56 proceeds to step S143 and obtains a list of conference schedules based on schedule information included in the schedule service 36 of the external service group system 12. For example, the conference schedule setting unit 56 displays a schedule list screen 1040 illustrated in FIG. 35 and causes the user to select a conference schedule. FIG. 35 is a diagram illustrating an exemplary schedule list screen according to the second embodiment.

In step S144, the conference schedule setting unit 56 indicates, to the participant management unit 44, prospective conference participants included in the conference schedule selected by the user, and causes the prospective conference participants to be added to the participant management information list. In step S145, the conference schedule setting unit 56 reads out and displays an attachment for the conference schedule selected by the user.

Also, in step S141 of FIG. 32, the permission inquiring process is performed by a procedure illustrated in FIG. 33. In the permission inquiring process illustrated in FIG. 33, the conference schedule setting unit 56 checks an authentication/detection source of the first participant, and determines whether the permission to perform the “Load Schedule” action is granted by referring to the permission setting table on a per-authenticator/detector basis illustrated in FIG. 31.

When the permission to perform the “Load Schedule” action is “granted”, the permission management unit 54 returns “permission granted” to the conference schedule setting unit 56 in step S153. When the permission to perform the “Load Schedule” action is not “granted”, the permission management unit 54 proceeds to step S154 and searches an authenticator/detector (“ICCARD”) having the permission to perform the “Load Schedule” action by referring to the permission setting table on a per-authenticator/detector basis of FIG. 31.

In step S155, the permission management unit 54 returns “not permitted” to the conference schedule setting unit 56, together with information of the authentication/detection source “ICCARD” to which the permission to perform the “Load Schedule” action is granted.

In step S144 of FIG. 32, the prospective participant adding process is performed by a procedure illustrated in FIG. 34, for example. In step S161, the participant management unit 44 obtains external service setting information of the first participant (current participant) from the external service setting information unit 20. In step S162, the participant management unit 44 excludes a participant corresponding to the external service user ID of the current participant from prospective conference participants included in the conference selected by the user. In step S163, the participant management unit 44 requests the user information unit 22 to search user information corresponding to the external service user ID of the prospective conference participant.

When there is user information corresponding to the external service user ID, the participant management unit 44 adds a user ID of the prospective conference participant to the participant management information list of FIG. 36 in association with the authentication/detection source “SCHEDULE”. When there is no user information corresponding to the external service user ID, the participant management unit 44 skips step S165. FIG. 36 is a diagram illustrating an exemplary participant management information list after the authentication/detection source is added.

In the following, the flowchart illustrated in FIG. 32 will be described in more detail by taking, as an example, the schedule information of FIG. 30, the permission setting table on a per-authenticator/detector basis of FIG. 31, the user service account information of FIG. 5, and the external service setting information of FIG. 7. A participant with the user ID “user001” is detected as a conference leader by the IC card 630.

It is assumed that user information of the user ID “user001” illustrated in FIG. 7, external service setting information of the external service setting ID “connectla” illustrated in FIG. 8, and user service account information of the user ID “office1” illustrated in FIG. 5 are obtained, and the participant with user ID “user001” is added to participant management information as a first participant by the participant management unit 44.

In response to receiving an instruction to load a schedule, the conference schedule setting unit 56 requests the permission management unit 54 to determine whether the authentication/detection source “ICCARD”, which has detected the first user with the user ID “user001”, has the permission to perform the “Load Schedule” action based on the permission setting table on a per-authenticator/detector basis illustrated in FIG. 31. In this case, because the permission to perform the “Load Schedule” action is “granted”, the permission management unit 54 returns “permission granted” to the conference schedule setting unit 56.

Next, the conference schedule setting unit 56 receives the user ID “user001” and the external service setting ID “connectla” of the first participant from the participant management unit 44. By referring to the external service setting information of the external service setting ID “connectla”, the conference schedule setting unit 56 uses an external service authentication token “eyJhbGcll . . . ” to connect to the schedule service 36 of address information “office.example.com”. Accordingly, schedule information of a schedule ID “sch-1” in which the user ID “office1” is set as an owner user can be obtained.

Based on the obtained schedule ID “sch-1”, the conference schedule setting unit 56 displays the schedule list screen 1040 of FIG. 35, and causes the user to select a conference schedule on the schedule list screen 1040 of FIG. 35. Upon the user selecting the conference on the schedule list screen 1040 of FIG. 35, the conference schedule setting unit 56 indicates the external service setting ID “connect1a” and prospective participants “office1 and office2” to the participant management unit 44.

The participant management unit 44 refers to the external service setting information of the external service setting ID “connect1a”, which corresponds to the ID “user001” of the participant. In this case, because the external service user ID of the external service setting information is “office1”, the participant management unit 44 excludes “office1” from the indicated prospective participants “office1 and office2”.

Next, the participant management unit 44 requests information about the prospective participant “office2” from the user information server apparatus 10. The external service setting information unit 20 of the user information server apparatus 10 refers to external service setting information of the external service user ID “office2” of FIG. 8 and returns an external service setting ID “connect2a” and a user ID “user002”.

The participant management unit 44 adds the user ID “user002”, obtained by requesting the information about the external service user ID “office2”, to the participant management information list of FIG. 36 in association with the authentication/detection source “SCHEDULE”.

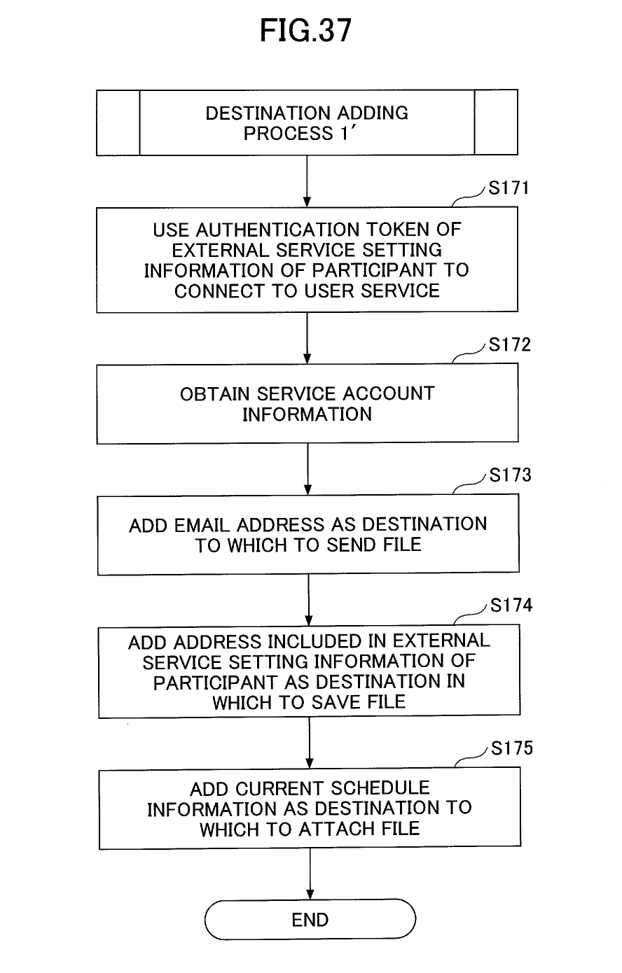

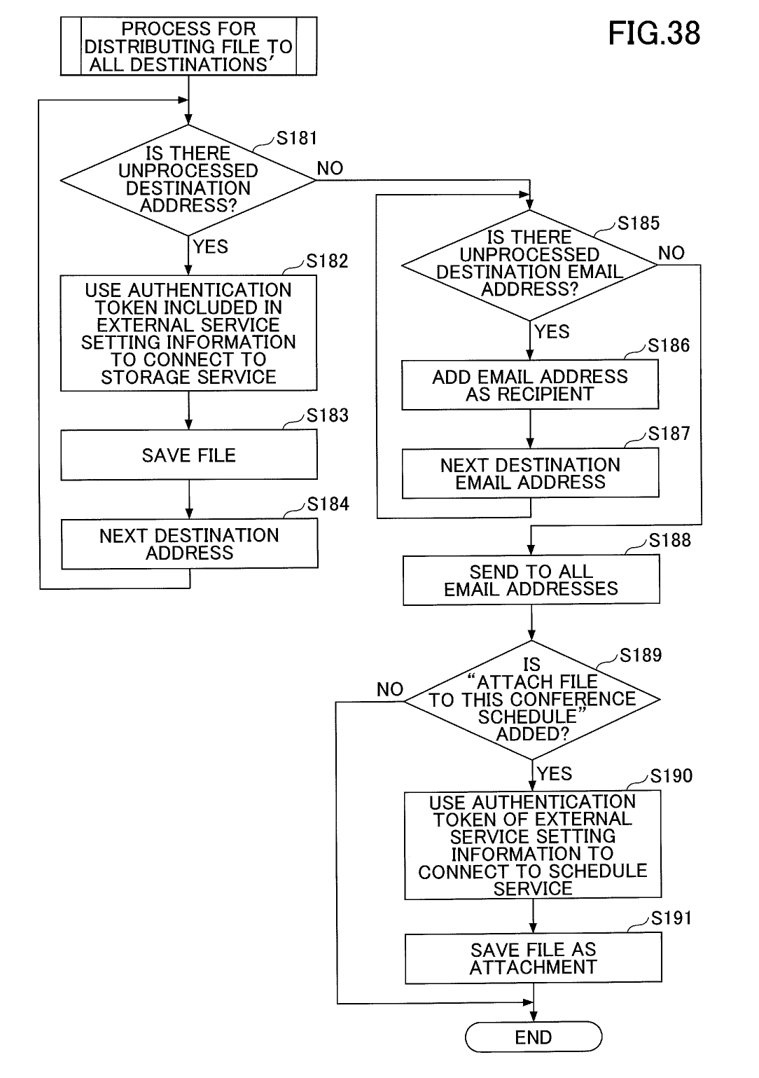

After the conference schedule setting process of FIG. 32 is completed, a batch distribution process is performed. The batch distribution process described in the flowcharts of FIG. 27 and FIG. 28 can be replaced with the batch distribution process illustrated in FIG. 37 and FIG. 38. FIG. 37 is a flowchart illustrating an exemplary destination adding process. FIG. 38 is a flowchart illustrating an exemplary process for adding a destination in accordance with a destination type.

In step S171, the batch distribution unit 42 uses an external service authentication token included in the external service setting information illustrated in FIG. 8 to connect to the user service 30. In step S172, the batch distribution unit 42 obtains user service account information of the participant from the user service 30.

In step S173, the batch distribution unit 42 adds an email address included in the user service account information as a destination to which to send a file. In step S174, the batch distribution unit 42 adds an address included in the user service account information as a destination in which to save the file. In step S175, the batch distribution unit 42 adds the current schedule information as a destination to which to attach the file.

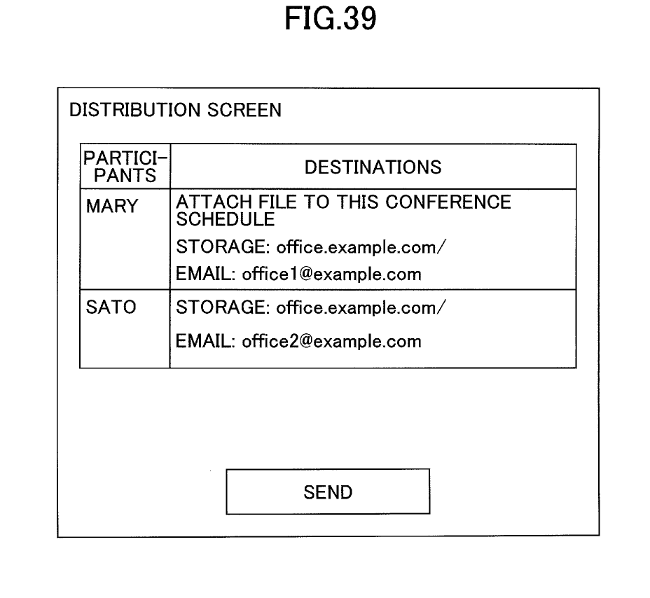

As a result, a distribution screen is created as illustrated in FIG. 39. FIG. 39 is a diagram illustrating an exemplary distribution screen according to the second embodiment. On a distribution screen 1030 illustrated in FIG. 39, “attach file to this conference schedule” is added as a destination.

In the process for sending a file to all destinations illustrated in FIG. 38, a file containing contents displayed on the electronic whiteboard apparatus 14 is distributed to all destinations, which have been associated with the participants as a result of the destination adding process of FIG. 37. Steps S181 through S188 are the same as steps S131 through 5138, and thus a description thereof will be omitted.

In step S189, if “attach file to this conference schedule” is added as a destination on the distribution screen 1030 after the destination adding process of FIG. 37, the batch distribution unit 42 performs steps S190 and 5191. In step S190, the batch distribution unit 42 uses an external service authentication token of the external service setting information to connect to the schedule service 36. In step S191, the batch distribution unit 42 stores the file, containing contents displayed on the electronic whiteboard apparatus 14, in the connected schedule service 36 as additional information about the conference.

For example, in order to store the file to the schedule information of the schedule ID “sch-1”, the batch distribution unit 42 uses the external service authentication token of the external service setting ID “connectla”, which corresponds to the owner user “office1”, to connect to the schedule service 36, and stores the file as an attachment. In this way, a conference schedule itself can be included as a destination, to which a file containing contents being displayed on the electronic whiteboard apparatus 14 is sent. Accordingly, it becomes easier to distribute a file as a conference deliverable.

### Third Embodiment

In the second embodiment, when an authentication/detection source of a participant is “FACE”, the “Load File” and “Load Schedule” actions are prohibited. This is because, firstly, there may be a possibility that a participant's face may be impersonated by, for example, placing a picture of the participant's face onto the face image detecting unit 50. Secondly, if a person who resembles the participant is mistakenly detected as the participant, wrongdoing may be made without the knowledge of the participant.

However, if the electronic whiteboard apparatus 14 is placed inside a company building where security is ensured to a certain extent and monitoring cameras are installed, impersonation risks related to suspicious behavior will be low. Also, a problem of false detection may become acceptable by taking the following points into account.

If a participant is preliminarily registered as a prospective conference participant, the participant receives an announcement indicating that a conference is to be held. Thus, there is an effect of preventing wrongdoing. Also, the accuracy of face authentication can be increased by preliminarily providing information on prospective participants. Further, if the schedule service 36 requires implicit consent of prospective participants, security risks can be further reduced.

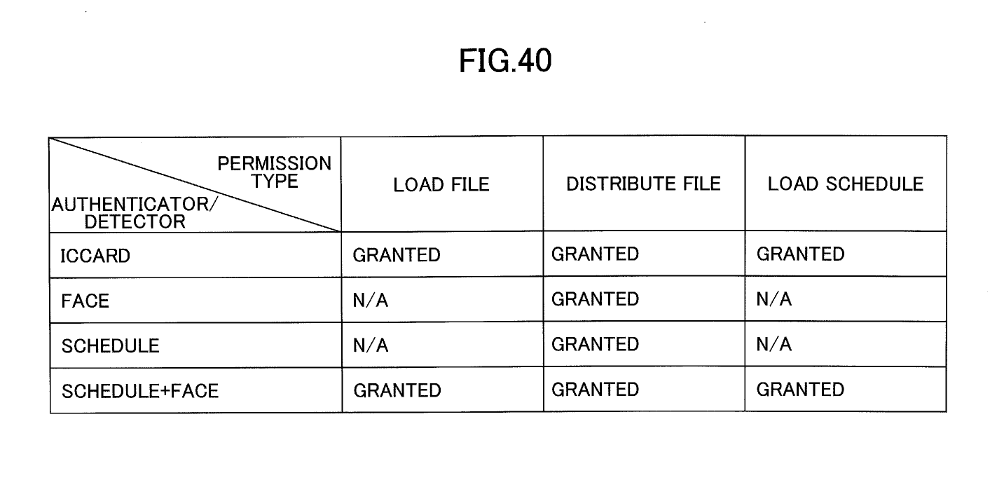

In the third embodiment, as illustrated in FIG. 40, the permission to perform the “Load File” and “Load Schedule” actions are granted to a combination of the authenticators/detectors “SCHEDULE” and “FACE”. FIG. 40 is a diagram illustrating an exemplary permission setting table on a per-authenticator/detector basis according to the third embodiment.

In the permission setting table on a per-authenticator/detector basis of FIG. 40, the combination of the authenticators/detectors “SCHEDULE” and “FACE” takes priority. Thus, a prospective participant who is preliminarily registered can execute all the actions by additionally performing face authentication. Conversely, a prospective participant who is not preliminarily registered (not indicated) is permitted to perform the “Distribute File” action only. Accordingly, it is possible to reduce security risks while maintaining convenience.

Further, the permission to perform the “Distribute File” action is granted to a prospective participant who is preliminarily registered. Thus, even if the participant does not participate in a conference and is not authenticated by face authentication, the participant can be subjected to the batch distribution process, thereby maintaining convenience.

Furthermore, in the third embodiment, the permission to perform the “Load File” and “Load Schedule” actions may be granted to a combination of the authenticators/detectors “SCHEDULE” and “ICCARD”. In a permission setting table in which the permission to perform the “Load File” and “Load Schedule” actions is granted to the combination of the authenticators/detectors “SCHEDULE” and “ICCARD”, a preliminarily registered prospective participant can be subjected to the batch distribution process, and can also execute all the actions by additionally performing IC card authentication. Accordingly, it is possible to reduce security risks while maintaining convenience.

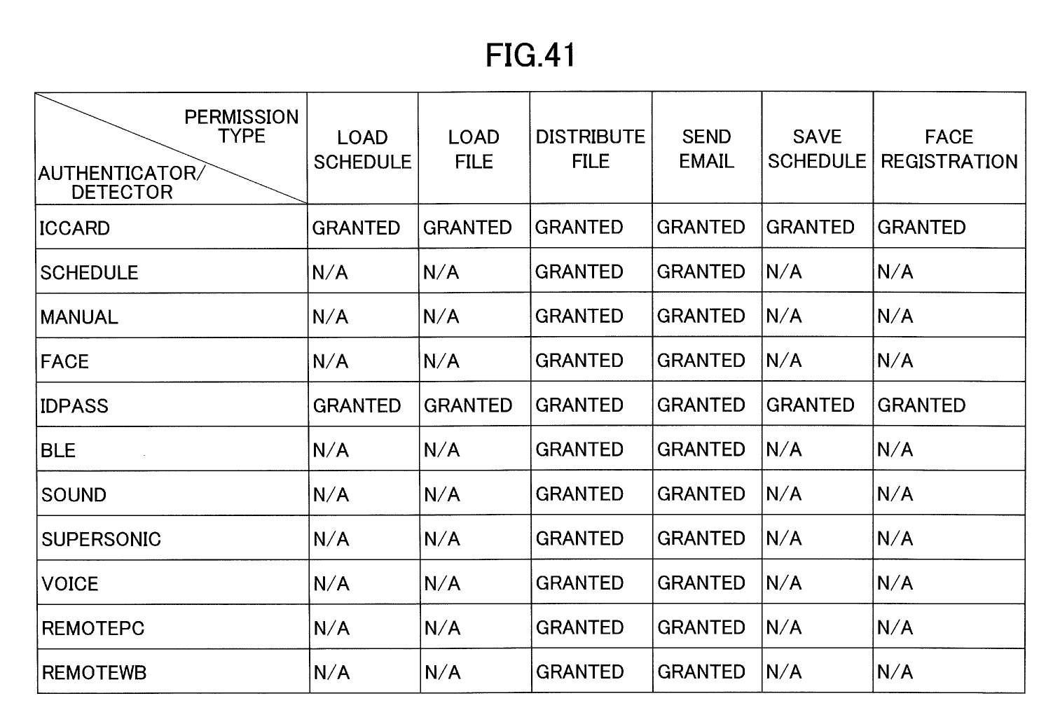

FIG. 41 is a diagram illustrating an exemplary permission setting table for various authenticators/detectors. FIG. 41 illustrates an example of a variety of authenticators/detectors and permission types. An authenticator/detector “MANUAL” indicates that a participant is added (detected) by a user operation performed on a participant setting screen.

An authenticator/detector “IDPASS” indicates that a participant is added (detected) by authentication using a user ID and a password. An authenticator/detector “BLE” indicates that a participant is detected upon the approach of a near-field communication (such as Bluetooth (registered trademark)) device owned by the participant and preliminarily registered (paired).

An authenticator/detector “SOUND” indicates that a participant is identified and detected by a preliminarily registered (paired) sound pattern played back from a terminal. An authenticator/detector “SUPERSONIC” indicates that a participant is identified and detected upon the approach of a terminal owned by the participant and emitting a preliminarily registered Maired) ultrasonic wave pattern.

An authenticator/detector “VOICE” indicates that a participant is identified and detected when a preliminarily registered voice pattern matches a voice pattern of the participant. An authenticator/detector “REMOTEPC” indicates that a participant is detected by user information when the participant with authentication connects to the electronic whiteboard apparatus 14. An authenticator/detector “REMOTEWB” indicates that, when one electronic whiteboard apparatus 14 communicates with another electronic whiteboard apparatus 14 so as to share contents, a participant is detected on the other electronic whiteboard apparatus 14.

In the permission setting table for various authenticators/detectors of FIG. 41, a participant detected by the IC card 630 has the permission to load a file. A participant detected as a prospective participant of schedule information may be readily impersonated and thus does not have the permission to load a file, thereby preventing information leakage.

The permission setting table for various authenticators/detectors of FIG. 41 may differ for each apparatus such as the electronic whiteboard apparatus 14 or for each organization to which users belong, in accordance with an operational state or an installation place of each authenticator/detector, or a policy of installation personnel.

The authenticators/detectors according to the present embodiment are merely exemplary. All combinations are not necessarily combinations of authenticators/detectors and actions. Combinations of authenticators/detectors and security levels and combinations of security levels and actions may be used.

Further, the present invention is not limited to these embodiments, but various variations and modifications may be made without departing from the scope of the present invention. The information processing system 1 described in the embodiments is merely exemplary. Needless to say, there may be various system configuration examples in accordance with applications and purposes.

What is claimed is:

1. An information processing system including a plurality of authentication methods for identifying a user, the information processing system comprising:
a memory; and
a processor coupled to the memory and configured to
identify the user by a given authentication method of the plurality of authentication methods, the authentication methods being associated with actions allowed to users,
receive an instruction to execute an action from the user,
make a determination whether the instruction to execute the action is allowed based on the given authentication method, and
execute the action or restrict the action from being executed based on a result of the determination.

2. The information processing system according to claim 1, wherein the processor is configured to allow an instruction to distribute a file to the user for the given authentication method, and not to allow an instruction to load a file that is owned by the user for the given authentication method.

3. The information processing system according to claim 1, wherein the processor is further configured to
store settings for using an external service each associated with a corresponding user of one or more users, and
obtain schedule information in which the one or more users are registered, from a schedule service included in the external service,
wherein the processor is configured to determine whether the instruction to execute the action is allowed based on the schedule information in which the one or more users are registered.

4. The information processing system according to claim 1, wherein, when the action is restricted from being executed based on the determination result, the processor is configured to provide the user with information of an authentication method for which the instruction to execute the action is allowed.

5. The information processing system according to claim 1, wherein the processor is configured to determine whether the instruction to execute the action is allowed based on a combination of the plurality of authentication methods.

6. An electronic whiteboard apparatus including a plurality of authentication methods for identifying a user, the electronic whiteboard apparatus comprising:
a memory; and
a processor coupled to the memory and configured to
identify the user by a given authentication method of the plurality of authentication methods, the authentication methods being associated with actions allowed to users,
receive an instruction to execute an action from the user,
make a determination whether the instruction to execute the action is allowed based on the given authentication method, and
execute the action or restrict the action from being executed based on a result of the determination.

7. A non-transitory recording medium storing a program that causes an electronic whiteboard apparatus including a plurality of authentication methods for identifying a user to execute a process comprising:
identifying the user by a given authentication method of the plurality of authentication methods, the authentication methods being associated with actions allowed to users;
receiving an instruction to execute an action from the user;
making a determination whether the instruction to execute the action is allowed based on the given authentication method; and
executing the action or restricting the action from being executed based on a result of the determination.
